(19) United States
(12) Patent Application Publication
(10) Pub. No.: US 2023/0089297 A1
(43) Pub. Date: Mar. 23, 2023

(54) ADJUSTING A USER EQUIPMENT ACTIVITY TIMING BASED ON MULTIPLE SIGNAL SOURCES FOR WIRELESS NETWORK

(71) Applicant: NOKIA TECHNOLOGIES OY, Espoo (FI)

(72) Inventors: Knud Knudsen, Aabybro (DK); Frank Frederiksen, Klarup (DK)

(21) Appl. No.: 17/904,940

(22) PCT Filed: Feb. 19, 2021
(86) PCT No.: PCT/FI2021/050123

§ 371 Date: Aug. 24, 2022

(30) Foreign Application Priority Data
Feb. 25, 2020 (FI) 20205193

(51) Int. Cl. H04W 74/08; H04W 68/02; H04W 24/08

(52) U.S. Cl. CPC H04W 74/0816; H04W 68/02; H04W 24/08

(57) ABSTRACT

A method includes determining an initial activity timing for a user device for each of a plurality of signal sources, wherein the activity timing for the user device with respect to a signal source indicates a timing of a user device activity that should be performed by the user device with respect to the signal source; and determining an adjusted activity timing for the user device for at least one of the plurality of signal sources, such that a time order of a user device activity performed by the user device for the plurality of signal sources are arranged in time for the user device based on a length of an activity period for the plurality of signal sources, wherein the activity period for a signal source includes a time period between successive user device activities for a signal source. Other example embodiments are provided.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT), and may offer new types of mission-critical services. For example, ultra-reliable and low-latency communications (URLLC) devices may require high reliability and very low latency.

### SUMMARY

According to an example embodiment, a method may include determining an initial activity timing for a user device for each of a plurality of signal sources, wherein the activity timing for the user device with respect to a signal source indicates a timing of a user device activity that should be performed by the user device with respect to the signal source; and determining an adjusted activity timing for the user device for at least one of the plurality of signal sources, such that a time order of a user device activity performed by the user device for the plurality of signal sources are arranged in time for the user device based on a length of an activity period for the plurality of signal sources, wherein the activity period for a signal source includes a time period between successive user device activities for a signal source.

According to an example embodiment, a method may include determining an initial paging timing for a user device for each of a plurality of paging sources, wherein the paging timing for the user device with respect to a paging source indicates a timing of paging monitoring instances when the user device should monitor for paging messages from the paging source; and determining an adjusted paging timing for the user device for at least one of the plurality of paging sources, such that a time order of a paging monitoring instance for the plurality of paging sources for the user device is arranged based on a length of paging cycle for the plurality of paging sources, wherein a paging cycle for a paging source comprises a time period between successive paging monitoring instances for a paging source.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating paging monitoring instances for four SIMs or four paging sources according to an example embodiment where paging monitoring instances are not arranged based on paging cycle.

FIG. 3 is a diagram illustrating paging monitoring instances for four SIMs or four paging sources where paging monitoring instances are arranged based on length of paging cycle according to an example embodiment.

FIG. 4 is a diagram illustrating measurement of signals during time gaps between paging monitoring instances for a plurality of paging sources according to an example embodiment.

FIG. 5 is a flow chart illustrating techniques that may be used to determine when to adjust a paging timing (or UE activity period) according to example embodiment.

FIG. 6 is a table identifying four different combinations or orders of paging monitoring instances for four paging sources (SIM1, SIM2, SIM3 and SIM4) according to an example embodiment.

FIG. 7 is a flow chart illustrating operation of a wireless node (e.g., user device, UE, network node, BS or gNB) according to an example embodiment.

FIG. 8 is a flow chart illustrating operation of a wireless node (e.g., user device, UE, network node, BS or gNB) according to another example embodiment.

FIG. 9 is a block diagram of a wireless station, wireless node or network entity (e.g., AP, BS, gNB, UE, or user device, or other network node or network entity) according to an example embodiment.

### DETAILED DESCRIPTION

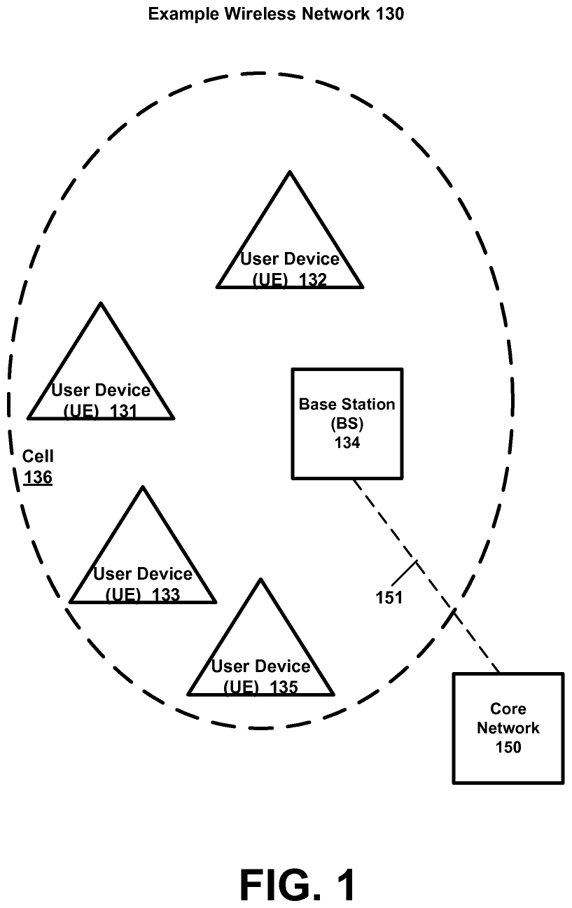

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB) or a network node. At least part of the functionalities of an access point (AP), base station (BS) or (e)Node B (eNB) may also be carried out by any node, server or host which may be operably coupled to a transceiver, such as a remote radio head. BS (or AP) 134 provides wireless coverage within a cell 136, including to user devices 131, 132, 133 and 135. Although only four user devices (or UEs) are shown as being connected or attached to BS 134, any number of user devices may be provided. BS 134 is also connected to a core network 150 via a 51 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC).

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to a eMBB UE (or an eMBB application running on a UE).

The various example embodiments may be applied to a wide variety of wireless technologies or wireless networks, such as LTE, LTE-A, 5G, cmWave, and/or mmWave band networks, IoT, MTC, eMTC, eMBB, URLLC, etc., or any other wireless network or wireless technology. These example networks, technologies or data service types are provided only as illustrative examples.

There may be a number of activities that a UE may perform, or may be requested to perform, based on a timing (e.g., at specific times, which may be indicated or scheduled, or which may even have a specific cycle or period) indicated or scheduled for such UE activities, e.g., such as: a UE monitoring paging monitoring instances (or paging occasions) from one or more paging sources, a UE receiving and/or measuring reference signals from each of one or more reference signal sources, a UE sending a measurement report or other information to each of one or more signal sources or network nodes, or a UE receiving data from each of one or more data sources. However, if separate UE activities are spaced apart by a significant period of time, this may require the UE to remain in an active state, which may be very power inefficient, as this may delay the time when the UE can transition to an Idle state or low power state. Thus, according to an example embodiment, UE power efficiency may be improved by determining an adjusted activity timing for the UE for at least one UE activity. As described in greater detail, e.g., in order to improve UE power savings, according to an example embodiment, an adjusted activity timing may be obtained or determined by a UE for at least one UE activity such that a time order of a UE activity for (e.g., each of) a plurality of signal sources or network nodes may be arranged in time for the user device based on a length of an activity period (or activity cycle time) for a UE activity for the plurality of signal sources or network nodes.

According to an example embodiment, a UE may be performing multiple UE activities associated with different signal sources or associated with different network nodes. For example, a UE may wake from a low power state, perform an activity with respect to each (or one or more) of multiple signal sources or associated with multiple network nodes, and the return to sleep (or idle or low power state). According to an example embodiment, in order to improve power savings, it may be desirable to align (or group together) these plurality of UE activities, or at least place or arrange these activities closer together, so as to reduce the period of time that the UE may be required to be in an awake state to perform these UE activities for multiple signal sources or network nodes. The plurality of UE activities may include, for example, the UE: monitoring a paging monitoring instance(s), for a paging message, from each of a plurality of paging sources; receiving and/or measuring reference signals from each of a plurality of reference signal sources; sending a measurement report or other information to each of one or more signal sources or network nodes; or receiving data from each of one or more data sources (e.g., UE receiving data associated with a different application or service). Each of the signal sources may be associated with a different network, a different radio access technology (RAT), or a different wireless operator, for example.

Each of these UE activities, for each signal source or network node, may have its own UE activity cycle (or activity period), which may be the period of time between successive UE activities with respect to a signal source or network node for the user device. As an illustrative example, an activity period for receiving data may be a period of time between when the UE receives or is expected to receive data (e.g., VoIP data, or data associated with a particular application) from a data source. Thus, the UE may be receiving data for each of a plurality of applications (e.g., from different signal sources), including from signal source 1 (e.g., VoIP data), signal source 2 (email data), signal source 3 (e.g., web browser data), etc. Each of these signal sources or applications may generate or provide data at different time intervals or activity periods. As described in greater detail herein, power efficiency or power savings for the UE may be improved if a timing or order of the UE activities are adjusted, such that a time order of a UE activity for the plurality of signal sources are arranged based on a length of an activity period for the plurality of signal sources. For example, by arranging a time order of a UE activity for the plurality of signal sources, this may reduce (at least in some cases or for some periods of time) the period of time that the UE may typically need to remain in an awake (or active or full power) state in order to perform the UE activities for the plurality of signal sources (e.g., to receive data from each of a plurality of signal sources, or monitor paging monitoring instances for each of a plurality of paging sources, or receiving reference signals from each of a plurality of reference signal sources).

Thus, according to an example embodiment, a method may include determining an initial activity timing for a UE for each of a plurality of signal sources, wherein the activity timing for the UE with respect to a signal source indicates a timing of a UE activity that should be performed by the UE with respect to the signal source; and determining an adjusted activity timing for the UE for at least one of the plurality of signal sources, such that a time order of a UE activity performed by the UE for the plurality of signal sources are arranged in time for the UE based on a length of an activity period for the plurality of signal sources, wherein the activity period for a signal source includes a time period between successive UE activities for the plurality of signal sources.

In an example embodiment, the determining an adjusted activity timing for the UE (or user device) for at least one of the plurality of signal sources may include: sending, by the UE, a request for the adjusted activity timing for at least one of the plurality of signal sources for the UE; and receiving, by the UE, a response that includes information identifying the adjusted activity timing for at least one of the plurality of signal sources for the UE.

Also, in an example embodiment, the adjusted activity timing for the UE may be determined such that a time order for the UE activity for the plurality of signal sources will be arranged in either descending order of length of activity period or ascending order of length of activity period for the plurality of signal sources. Also, for example, the adjusted activity timing may be determined such that UE activities, for the plurality of signal sources for the UE, having a same length of activity period, will be grouped together or adjacent to each other in time, either with or without a time gap therebetween. In this illustrative example, by grouping or arranging UE activities in accordance with their activity period or cycle (e.g., in ascending or descending order, this may reduce the period of time that the UE may be required to perform the UE activities for the plurality of signal sources, thereby improving power savings for the UE. For example, paging timing may be described herein as an illustrative example of a UE activity, but timing of other UE activities may also be adjusted (e.g., a time order of UE activities for different signals sources may be arranged in time based on activity period or cycle for the signal sources) so as to improve UE power efficiency.

According to an illustrative example, packet data traffic is often very bursty, e.g., such as with occasional periods of transmission activity followed by longer periods of silence. Rather than have a UE continuously monitor a downlink channel for downlink data (which would consume significant UE power), a UE may use a discontinuous reception (DRX) to reduce power consumption. According to an example embodiment, monitoring may include receiving (or attempting to receive) and/or decoding downlink control information on a channel, and determining if one or more specific signals have been received on the channel. For example, monitoring may include receiving downlink control information on a channel, and determining if one or more specific signals have been received that indicate the presence of downlink data on the downlink data channel or the presence of an UL transmission grant for use of the uplink data channel.

According to DRX, a UE monitors downlink control signaling for a paging message only at specific time instants (e.g., according to a paging timing for the UE, or according to a DRX cycle for the UE), such as every 100 ms or other paging timing (e.g., where the paging timing defines or determines the paging time instants when paging messages may be received by the UE). Thus, for example, a paging cycle (or DRX cycle) may be defined for a UE, in which the UE may sleep (e.g., placing one or more of its circuits, or the receiver and/or transmitter of the UE off or in a low power state) most of the time, and only briefly wake (powering on its circuits, receiver and/or transmitter) to monitor or receive downlink control signaling to determine if the network (e.g., CN or BS) has downlink data to be transmitted to the UE.

For example, upon waking from a sleep or low power state, the UE may monitor (e.g., receive and/or decode) downlink control information (DCI) on a physical downlink control channel (PDCCH) for the presence of a paging message, e.g., which may be (as an example) information encrypted by a paging identifier, such as information encrypted with a paging-radio network temporary identifier (P-RNTI). The presence of a paging message (e.g., which may be, for example, information encrypted with the P-RNTI) indicates that the network may have downlink data for delivery to the UE. For example, if the UE detects a paging message (e.g., detects the P-RNTI) on the DCI, the UE may then receive (decode) further control information (e.g., within a resource or resource block indicated by the paging message) to determine if its UE identity is indicated or provided in this further control information. If the UE finds its UE identity, then this indicates that the core network has downlink data for delivery (transmission) to the UE. After detecting its UE identity, the UE may perform a random access (RA or RACH) procedure with a cell or BS (or eNB/gNB) to establish a connection (for the UE to transition to a connected state) with the cell, and then the UE may receive the downlink data from the core network via the cell. After receiving the downlink data (and possibly sending/transmitting any data it may need to transmit), the UE may then, for example, re-enter or resume the sleep state or low power state (which may be, for example, DRX sleep state in RRC_CONNECTED, DRX sleep state in RRC_IDLE state or RRC_INACTIVE state, as illustrative examples, where RRC refers to radio resource control), and remain in this sleep state until the next paging monitoring instance or paging occasion (e.g., as indicated by the DRX cycle in terms of a paging pattern or PDCCH monitoring pattern for the UE) that the UE needs to wake from sleep again (e.g., power on its receiver and other circuits) and check for e.g., a paging or scheduling message on the downlink control information.

A paging pattern or paging timing may include or may indicate one or more times (time instants or paging monitoring instances) when a UE should wake from sleep and check for a paging message, and then, e.g., if a paging message is detected, check for its UE identity in a resource block or channel.

Thus, paging is a network technique that may be used to contact the UE for the cases of downlink traffic to be delivered or transmitted to the UE. For RRC_Idle and/or RRC_Inactive UEs, this is typically implemented as a paging mechanism where the network and the UE have a common understanding of how and when the UE should be monitoring a channel for paging message(s) from the network (core network). According to an example embodiment, to have a statistical distribution of UEs in the time domain, the time instants where UEs will listen or monitor for paging messages may be distributed through an algorithm which will define the UE paging frame as a combined function of the UE (UE unique or UE-specific, at least within a network) identity and the system timing. For LTE the paging frame may be the radio frame where the UE will listen for paging messages, and depending on configuration, the UE may further have an assigned (still from the UE_ID) a subframe within the paging frame. It is possible for the eNB/BS to control the amount and/or distribution of UEs in the time/resource domain by configuring paging related DRX parameters. The procedures may be similar for NR/5G, and the inactive (e.g., RRC_Inactive) UE may listen or monitor a channel for CN paging, calculated using the NR-equivalent IMSI, called 5G-S-TMSI, and RAN paging using the RRC_Inactive RNTI: I-RNTI. Furthermore, in NR (5G), when multiple beams are used for paging transmission, a paging occasion (PO) may include a set of PDCCH (physical downlink control channel) monitoring occasions—one for each beam—and these PDCCH monitoring occasions are allocated in time. For these reasons, a table-based PO (paging occasion) configuration mechanism of LTE has been replaced in NR/5G by a mechanism based on the pagingSearchSpace. These are merely some illustrative examples of how a UE may determine or find its paging timing, such as its PF and/or PO. Also, these are some illustrative examples of UE identities that may be used for UEs.

Thus, according to an illustrative example embodiment, a UE may determine its paging timing by determining a paging frame (PF) and/or one or more paging occasions (PO) within the PF where (when) the UE should monitor for a paging message. According to an example embodiment, a paging frame (PF) may contain one or multiple PO(s). According to an example embodiment, a paging timing (e.g., which may be or may include a paging frame (PF) and/or a paging occasion (PO), and/or other time(s) of a paging monitoring instance(s)), indicating when the UE should monitor downlink control information for a paging message, may be determined based on a UE identity (e.g., UE_ID) for the UE.

As noted, according to an illustrative example embodiment, the UE may use Discontinuous Reception (DRX) in RRC_IDLE and RRC_INACTIVE state in order to reduce power consumption. The UE may, for example, monitor (e.g., receiving downlink signals to detect a paging message) one or more paging occasions (POs) per DRX cycle. A PO may include a set of PDCCH monitoring occasions and/or may include multiple time slots (e.g., subframe or OFDM symbol) where a paging message may be transmitted to the UE. Also, for example, a Paging Frame (PF) may be a Radio Frame and may include one or multiple PO(s) or starting point of a PO. A same paging message may be used for both RAN (radio access network or BS) initiated paging and CN initiated paging.

By way of an illustrative example, a paging timing, e.g., which may include or may indicate one or more paging monitoring instances, such as a PF(s) and/or PO(s) (for example), may be determined based on the UE_ID for the UE, according to Eqn. 1. A SFN (system frame number) for the PF (paging frame) may be determined for the UE based on Eqn. 1 as follows:

(SFN+PF_offset)mod T=(T div N)*(UE_ID mod N); (Eqn. 1)

Index (i_s), indicates the start of a set of PDCCH (physical downlink control channeL0 monitoring occasions for the paging message, is determined by:

i_s=floor(UE_ID/N)mod Ns

For default association, Ns is either 1 or 2. For Ns=1, there is only one PO which starts in the PF. For Ns=2, PO is either in the first half frame (i_s=0) or the second half frame (i_s=1) of the PF.

For non-default association (i.e., when paging-SearchSpace is used), the UE monitors the (i_s+1)th PO where the first PO starts in the PF.

Some example parameters that may be used to determine PF and PO, based on Eqn. 1. T: DRX cycle of the UE. N: number of total paging frames in T; Ns: number of paging occasions for a PF; PF_offset: offset used for PF determination; UE_ID: a UE identifier, e.g., such as, for example, a 5G-S-TMSI (temporary mobile subscriber identity) mod 1024;

Parameters N, Ns, first-PDCCH-MonitoringOccasionOfPO, PF_offset, and the length of default DRX Cycle may be transmitted or signaled by BS/gNB within system information, such as within SIB1, for example. Also, other techniques may be used to determine a paging timing for a UE.

In normal UE operations in current networks, a UE will have a “hardcoded” (or static or fixed) UE (UE-specific) identity towards the core network. As one example, the UE may be assigned a fixed or static International Mobile Subscriber Identity (IMSI) or a fixed or static (5G or NR) Temporary Mobile Subscription Identifier (TMSI). The IMSI in LTE and 5G-S-TMSI in 5G/New Radio (NR) may be used by the UE to determine the paging timing (e.g., paging frame (PF)) for the UE, e.g., indicating the exact time that the UE should be monitoring network signaling (e.g., downlink control information) for a paging message. For example, the UE identifier may be converted (or used) by the UE through an equation, such as Eqn. 1 as an example, to calculate or determine the paging frame (as an example paging timing) for the UE. One function of the existing paging mechanisms is to distribute all devices connected to the network in a statistically fair manner such that there is an equal probability of having a given load on the available network resources (paging frame as one example). This mechanism provides a straight-forward mapping when considering a UE with a single identity and no need for network or UE control of loading of the available resources.

Some examples of a UE (UE-specific) identity may include an International Mobile Subscriber Identity (IMSI), or a (5G or NR) Temporary Mobile Subscription Identifier (TMSI). These are some examples of UE-specific (e.g., a different UE identity assigned to each UE within a network) UE identities, and other (UE-specific) UE identities may be used.

Thus, at least in some cases, according to an example embodiment, a paging timing for a UE may be associated with its UE identity (e.g., IMSI, TMSI, or other UE identity) assigned to the UE. For example, Eqn. 1 describes an example technique that may be used (as an example) by a UE to determine the paging timing (e.g., a PF, or one or more paging monitoring instances) that is associated with its UE identity. For example, a paging timing with respect to a paging source may indicate a timing (e.g., one or more times) of paging monitoring instances when the UE should monitor for paging messages from the paging source. A paging source may include any network node or other source that may transmit paging messages (e.g., BS, gNB, or other network node). A paging monitoring instance may be a time(s) (e.g., which may be indicated by, or associated with, a PF and/or PO, in some example embodiments) when the UE may receive a paging message from the paging source. Thus, a UE may or should monitor a channel (e.g., PDCCH) for a paging message for the one or more paging monitoring instances for the UE. Thus, as an illustrative example, a paging timing may indicate a time when the UE monitors or may receive (or a time when the UE should monitor) downlink control information for a paging message, and/or a paging timing may indicate a time when a paging message may be transmitted to the UE. In current networks, a paging timing for a UE will be fixed or static, based on a fixed or static UE identity (e.g., a fixed TMSI, IMSI) for the UE.

According to an illustrative example embodiment, a UE may be assigned multiple UE identifiers or multiple UE identities (e.g., multiple IMSIs, or multiple TMSIs), or the UE may be monitoring paging monitoring instances for (or from) a plurality of paging sources. These multiple UE identities may, for example, be associated with (or assigned by) a same network or network operator, or may be associated with (or assigned by) different networks or different network operators or mobile networks, and/or different radio access technologies (RATs). Similarly, for example, different paging sources may be associated with different wireless networks, different wireless or mobile network operators, and/or different radio access technologies (RATs). For example, a UE may have more than one SIM card active at a time (e.g., with a different UE identity associated with each SIM card, and a different paging timing for each of the UE identities, or the UE may have a different paging timing for each of the plurality of paging sources). As an illustrative example, a UE may support dual-SIM in IDLE mode (e.g., each SIM card may belong to or may be associated with a different mobile operator/network operator). Due to the two SIM cards and two associated UE identities assigned to the UE, this means that the UE should monitor paging channels (and possibly different frequency resources of these two different paging channels) of the two networks associated with the distinct SIM cards (or different UE identities). This may allow the UE to monitor paging messages from the multiple (e.g., two or more) network (mobile) operators. According to an example embodiment, one or more electronic SIM cards (eSIM) (e.g., a SIM that may be electronically assigned to the UE, and which does not require a physical SIM card to be installed on the UE) may also be assigned to a UE. Other techniques may be provided or used to assign additional UE identities to a UE. For example, a UE may receive a virtual UE identity (e.g., virtual IMSI), or other assigned UE identity (which may or may not be associated with a SIM card or eSIM). These are a few examples illustrating how a UE may be assigned multiple UE identities. Thus, in this manner, a UE may be assigned one or more electronic or virtual UE identities. For example, a network node associated with each UE identity assigned to the UE may be a paging source (e.g., may send one or more paging messages based on a paging timing). As noted, a paging timing for the UE may be associated with each of the UE identities, e.g., see Eqn. 1 for example. Alternatively, the UE may simply be assigned (or may determine) a paging timing for each of a plurality of paging sources, e.g., based on broadcast information associated with each paging source and/or based on control information from each of the paging sources that indicates paging timing for the paging source.

However, monitoring of a paging monitoring instance(s) from each of a plurality of paging sources, such as, for example, via an assignment of multiple UE identities to a UE, may cause one or more problems or challenges to arise, including for example: in some cases, a significant separation in time may occur between paging monitoring instances (or paging occasions) for the two (or more) UE identities (or paging sources) of the UE, which may cause significant power consumption because the UE may need to remain on or in active state for a relatively long (or longer) period of time (e.g., thus, delaying a transition of the UE to sleep state, Idle state or other low power state), or the UE may need to separately power back on—or transition from sleep state to awake state, to monitor paging messages for both UE identities (causing additional power consumption as this power on of circuits of the UE is performed for each of the two UE identities).

According to an example embodiment, there may be situations or applications in which it may be advantageous for a paging timing (or other UE activity timing) for a UE to be changed or adjusted. For example, a UE may monitor paging message(s) from each of a plurality of paging sources. In an illustrative example, each paging source may be associated with a same or different cell or BS/gNB, a same or different network, a same or different wireless operator or mobile operator, and/or a same or different radio access technology (RAT). In one example embodiment, each of a plurality of paging sources for a UE may be associated with a different wireless operator or mobile network operator, as an illustrative example. As an illustrative example, a UE may have a plurality of UE identities assigned to the UE, e.g., multiple SIMs may be assigned to the UE, with a SIM or UE identity being assigned to the UE from each of a plurality of wireless operators or wireless networks. Each paging source (e.g., each network node or BS/gNB, among multiple networks or among multiple wireless operators) may transmit paging messages to the UE based on its own paging cycle (e.g., DRX cycle) (e.g., where a paging cycle or DRX cycle may be or may indicate a time period between successive paging occasions or paging monitoring instances for the paging source for the UE). In an illustrative example, paging timing, e.g., a timing (or time) of paging occasions or paging monitoring instances, may be determined based on (or associated with) the UE identity assigned to the UE and/or associated with a paging source. Thus, in some cases, a UE may obtain an adjusted paging timing for a paging source by requesting and/or obtaining a new or virtual UE identity for or with respect to the paging source (or with respect to the network or operator associated with the paging source). The new UE identity (e.g., virtual IMSI (VIMSI)) may be mapped to an adjusted paging timing, e.g., via Eqn. 1, as an illustrative example. In another embodiment, paging timing (e.g., indicating a time(s) or timing of paging occasions or paging monitoring instances), such as an adjusted paging timing for a paging source, may be obtained by the user device from a network node of a network (e.g., BS/gNB), wireless operator, or other entity, e.g., in response to a request by the UE. The UE may even indicate in its request for a new or adjusted paging timing, a requested paging timing and/or a requested new UE identity that would provide the desired adjusted paging timing for the paging source for the UE.

According to an example embodiment, paging (or other activity) timing (e.g., indicating a timing or time(s) of paging monitoring instances or paging occasions when the UE should monitor paging messages for at least one paging source of a plurality of paging sources) may be adjusted for the UE for at least one of the plurality of paging sources for the UE, e.g., in order to reduce power consumption for the UE. According to an example embodiment, a paging cycle (or length of the paging cycle) for a paging source may be or may indicate a time period between successive (e.g., between two) paging monitoring instances for the paging source for the UE. In an example embodiment, to reduce UE power consumption, an adjusted paging timing may be determined or obtained for at least one paging source of a plurality of paging sources for a UE, such that a time order of a paging monitoring instance for (e.g., each of) the plurality of paging sources for the UE will be arranged in time order based on a length of paging cycle for the plurality of paging sources.

For example, arranging a paging monitoring instance(s) for a plurality of paging sources (e.g., a paging monitoring instance for a first paging source, a paging monitoring instance for a second paging source, and a paging monitoring instance for a third paging source, etc., for the UE) based on or in accordance with a length of paging cycle (e.g., either ascending or increasing in paging cycle length, or descending or decreasing in paging cycle length, or grouping together two or more paging monitoring instances for two paging sources having a same paging cycle length) may, at least in some cases or for at least a period of time, result in a more power efficient arrangement or grouping of paging monitoring instances or paging occasions for multiple paging sources for the UE. For example, paging monitoring instances for paging sources having a same or similar (e.g., same or within a threshold) length of paging cycle may thus be grouped together (adjacent to each other) in time, and this may result in a reduced power consumption for the UE, e.g., by decreasing an amount of time the (e.g., Idle mode) UE spends awake or in an awake state (e.g., by decreasing a time gap between paging monitoring instances of different paging sources), and decreasing the amount of time the UE may typically spend in a sleep (or low power) state and/or delaying when the UE may transition to a sleep or low power state.

Thus, in an example embodiment, ordering (in time) the paging occasions or paging monitoring instances for a plurality of paging sources for a UE based on length of paging cycle, e.g., ordering paging monitoring instances according to the (e.g., either ascending or increasing, or descending or decreasing) IDLE mode DRX cycle (or paging cycle) of the SIMs or UE identity (or the camped-on network associated with the SIM) may offer the benefit or advantage that the UE may be able to save power by having a shorter awake period to monitor the paging monitoring instance for the plurality of paging sources or plurality of SIMs/UE identities or networks, for example.

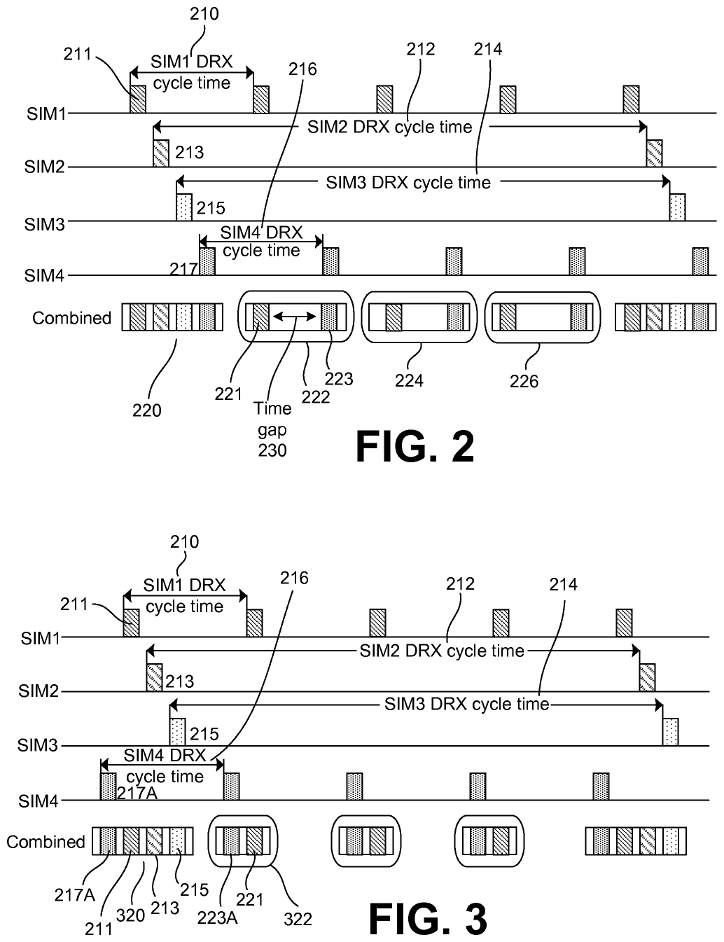

FIG. 2 is a diagram illustrating paging monitoring instances for four SIMs or four paging sources according to an example embodiment where paging monitoring instances are not arranged based on paging cycle. In this example, a paging source is associated with each SIM. Thus, the four SIMs assigned to the UE in this example result in 4 paging sources, with each paging source having its own paging cycle (e.g., where paging cycles of different paging sources may be the same length, or a different length). As an illustrative example, as shown in the 4-SIM example of FIG. 2, two of the networks (or paging sources) have a paging (or DRX) cycle of 64 frames (SIM1 and SIM4) and the other two networks or SIMs (or paging sources) (SIM2, SIM3) have a paging (or DRX) cycle of 256 frames. While being in IDLE mode (or sleep state or low power state), towards all networks, the UE only needs to perform paging receptions (monitoring for PDCCH with P-RNTI) from the networks (SIM2, SIM3) with DRX cycle of 256 frames every fourth time it wakes up for paging receptions for the two other networks (for SIM1, SIM4).

As shown in FIG. 2, paging cycles are shown for each SIM or paging source, e.g., including: SIM1 paging cycle (DRX cycle) 210 (e.g., 64 frames), SIM2 paging cycle 212 (e.g., 256 frames), SIM3 paging cycle 214 (e.g., 256 frames), and SIM4 paging cycle (e.g., 64 frames). Within a paging cluster (e.g., a group of paging monitoring instances within a window or threshold period of time) 220, the initial order of paging monitoring instances for the 4 SIMs/4 paging sources is: paging monitoring instance 211 of SIM1; paging monitoring instance 213 of SIM2; paging monitoring instance 215 of SIM3; and paging monitoring instance 217 of SIM4. Thus, initially, at paging cluster 220, a paging monitoring instance occurs for all 4 SIMs (or all 4 paging sources), including paging monitoring instances 211, 213, 215 and then 217, in that order. This initial order of paging monitoring instances for these paging sources/SIMs may be arbitrary, for example. However, initially, the order of paging monitoring instances of paging sources/SIMs are not ordered or arranged based on paging cycle for these paging sources (and the UE may detect that the order of paging monitoring instances of paging sources/SIMs are not ordered or arranged based on paging cycle for these paging sources). As a result, paging clusters 222, 224 and 226 include only paging monitoring instances from SIM 1 and SIM4 (the SIMs/paging sources with the shorter paging cycles of 64 frames). For example, paging cluster 222 includes paging monitoring instance 221 (of SIM1) and paging monitoring instance 223 (of SIM4). However, because these paging monitoring instances are not arranged based on paging cycle, these two paging monitoring instances (having the same paging cycle) have a significant gap in time for which paging monitoring instances of SIM2 and SIM3 would be present, at least for some clusters. But because the paging cycle for SIM2 and SIM3 are longer than paging cycles for SIM1 and SIM4, there is a time gap 230 between paging monitoring instances 221 and 223 for which the UE may need to remain awake (e.g., to monitor a channel for paging monitoring instance 223), thus resulting in a power inefficient performance of the UE. However, by arranging paging monitoring instances based on (or in accordance with) a length of paging cycle, this may group or cluster paging monitoring instances together that have a same or similar (e.g., within a threshold length) paging cycle, and thereby reduce power consumption of the UE (e.g., by allowing the UE to remain in a low power state or sleep state (e.g., Idle mode) longer, or resume a low power state or sleep state earlier, and avoid or reduce long non-monitoring time gaps, such as time gap 230, where the UE is awake but is not yet monitoring for paging messages).

FIG. 3 is a diagram illustrating paging monitoring instances for four SIMs or four paging sources where paging monitoring instances are arranged based on length of paging cycle according to an example embodiment.

In this example, the UE may have requested, and obtained, an adjusted paging timing for SIM4 (as an example), which causes the paging monitoring instance for SIM4 to move from paging monitoring instance 217 (FIG. 2) to paging monitoring instance 217A, such that paging monitoring instances for the 4 SIMs/4 paging sources are arranged or ordered in time based on or according to paging cycle (e.g., either in descending paging cycle or ascending paging cycle, or otherwise grouping together in time paging monitoring instances having a same or substantially the same (e.g., within a threshold, such as plus or minus 10%) paging cycle). Thus, as shown in the paging cluster 320, the paging monitoring instances within paging cluster 320 are grouped or ordered according to ascending (increasing) paging cycle, with those paging monitoring instances 217A (for SIM4) and 211 (for SIM1) grouped together and occurring first (both of these have shorter paging cycles or 64 frames), followed in time by paging monitoring instances 213 (for SIM2) and 215 (for SIM3) grouped together (both of these have longer paging cycles of 256 frames). Thus, at paging cycle 322, only the paging monitoring instances 221A (for SIM4) and 223 (for SIM1) occur (both having a shorter paging cycle of 64 frames in this example), and are much closer together than shown in FIG. 2, e.g., without a long time gap 230 being present (rather, a shorter time gap may be provided between paging monitoring instances 223A and 221 of paging cluster 322, as compared to the longer time gap 230 in FIG. 2 where the UE remains in an awake state). In this manner, by reducing the amount of time within paging cluster 322 (e.g., as compared to amount of time 230 in awake state for paging cluster 222, FIG. 2) that the UE must remain in awake state, this may reduce the power consumption for the UE. In general, a time gap may, at least in some cases, occur or be present, between adjacent paging monitoring instances 217A, 211, 213, 215, etc., such as to allow the UE to switch beams and/or switch frequencies. Thus, for example, as shown in FIG. 3, after adjusting paging timing for SIM4, a short(er) time gap (e.g., significantly shorter than time gap 230) may be present between paging monitoring instances 217A and 223A (FIG. 3), e.g., to allow beam switching and/or frequency switching for monitoring for pages for different paging sources (e.g., SIM4, SIM1). However, according to an example embodiment, at least in some cases, by arranging or ordering paging monitoring instances for a plurality of paging sources based on paging cycle (e.g., arranging paging monitoring instances based on ascending length of paging cycle, descending length of paging cycle, and/or grouping or clustering together in time paging monitoring instances that have a same (or similar, within a threshold) length of paging cycle).

In FIG. 3, SIM4 has moved in front of SIM1. Thus, as shown in FIG. 3, SIM4 and SIM1 paging occasions (POs) (or paging monitoring occasions or paging monitoring instances) occur first in order for UE. Alternatively, PO for SIM1 could have moved after PO for SIM4. Thus, one goal or objective may be, for example, to reduce the amount of time that the UE must be awake to monitor POs or paging monitoring instances for multiple paging transmissions. In addition, moving PO (or paging monitoring instance) timing requires interaction with BS, and thus, requires expenditure of UE power. Thus, in some cases, it may be desirable to adjust activity timing or paging timing that reduces or even minimizes the number of activity timing or paging timing adjustments or movements. For example, the UE may determine a PO (or paging monitoring instance) based on its IMSI and broadcasted periodicity of paging signal (paging cycle). Then, the UE may adjust its paging timing or activity timing (e.g., PO timing or paging monitoring instance timing) for that paging signal, e.g., based on a requested PO (or paging monitoring instance) timing offset, or based on a new UE identity (e.g., based on a new VIMSI assigned to the UE).

Thus, according to an example embodiment, paging monitoring instances (which may also be referred to as, or may include, POs), or other UE activities, may be ordered or arranged in a manner that may improve power efficiency for the UE. Thus, for example, the UE may order POs or paging monitoring instances for each paging signal (sort them, or arrange them in a time order) based on paging/DRX cycle (or based on length of paging cycle) of each paging signal. The order may be ascending, e.g., with the PO (or paging monitoring instance) of the shortest paging cycle first within a time period, or in ascending order with a PO (or paging monitoring instance) of the shortest paging cycle last within a time period, or otherwise may group together POs or paging monitoring instances that have a same or similar (e.g., within a threshold) length of paging cycle. By grouping together UE activities or POs/paging monitoring instances having a same or similar length of paging (or other UE activity) cycle, this may result (as shown in FIG. 3) in the POs or paging monitoring instances (e.g., 223A and 221, FIG. 3) that have a short/shorter length of paging cycle occurring or being adjacent to each other in time, which may reduce the time gap (e.g., see longer time gap 230 in FIG. 2) between such POs (e.g., paging monitoring instances 223A, 221) with a short paging cycle length. Thus, for example, in this manner, at least in some cases, the short (or shorter) cycle POs/paging monitoring instances (or other UE activities) will show up by themselves (or grouped together) to be monitored by the UE, and thus, they should be closer together, e.g., they may be adjusted to be adjacent to each other (e.g., this may thus advantageously arrange paging monitoring instances for different paging sources so as to avoid placing a paging monitoring instance for a long paging cycle between the paging monitoring instances that have a shorter paging cycle). Thus, the adjusting of paging timing or adjusting an order of POs/paging monitoring instances for different paging signals, may result in two or more paging signals having POs arranged to be adjacent to each other, and possibly in order, either ascending order (from shortest to longest paging cycle length) or descending order (from longest to shortest paging cycle length), e.g., which may be especially applicable where there may be POs/paging monitoring instances for 3 or more paging cycles or paging signals/paging sources (or UE activities for 3 or more signal sources or network nodes that may be arranged in ascending order or descending order, or those UE activities having a same or similar UE activity period may be grouped together).

According to an example embodiment, the timing of POs or paging monitoring occasions (or other UE activities) may be adjusted or rearranged, so as to improve UE power efficiency. However, even after one or more POs or paging monitoring occasions (or other UE activities) may be adjusted or rearranged, time gaps may still exist between the POs or other UE activities.

According to an example embodiment, even if the paging occasions or paging monitoring occasions (or other UE activities) are aligned or grouped together as far as possible, there may still be, for example, time gaps, e.g., such as time gaps of one or more slots between them (between POs, or between UE activities associated with different paging sources or signal sources) since the paging occasions or paging monitoring occasions may, for example, have a granularity of multiple slots (e.g., where a slot may be multiple symbols). If such time gaps exist between POs or paging monitoring instances or between other UE activities, the UE may potentially exploit these for doing inter frequency measurements and/or inter-RAT measurements. According to an example embodiment, the UE may use these time gaps to perform signal measurements for one or more neighbor cells.

Also, the timing of the paging occasions or paging monitoring instances or other UE activities may drift (or change) over time for instance due to non-synchronized networks and changed location of a moving UE. The different paging occasions or paging monitoring instances or other UE activities may drift independently since they are from different networks. Consequently, the paging occasions/paging monitoring instances or other UE activities may need to be re-aligned or adjusted or rearranged from time to time. When re-aligning the paging occasions or other UE activities, the ordering may, for example, again be done according to or based on a length of paging cycle or UE activity period, e.g., among multiple paging sources or signal sources for the UE. Further, in case a UE moves to other cells in the network where a different configuration for IDLE mode DRX may be used, the UE may correspondingly need to re-align the paging setup.

Also, for example, when UE moves around in Idle mode, it may move from one cell to another, try to measure signal strength from different cells, and may perform a cell reselection if the cell the UE is currently camping on becomes weak. These measurements of signal strength (e.g., RSSP/RSSI) from various neighbor cells may use the signal received adjacent to the POs/paging monitoring instances, so UE does not have to wake up twice. For example, neighbour discovery, to discover other cells, may typically include a UE receiving and measuring reference signals (e.g., SSBs, CSI-RSs, PTRSs) from other cells. For example, a UE may receive from a serving, a broadcast signal indicating a list of neighbour cells that the UE should monitor and measure signals (e.g., measures synchronization signal blocks (SSBs) and/or channel state information-reference signals (CSI-RSs) or other signals) of these neighbor cells, and report back such signal measurements (e.g., RSSI or RSSP or other signal measurement) to the serving cell/BS. Such measurements may be used, e.g., for handover or cell reselection decisions for the UE. According to an example embodiment, a UE may perform signal measurement of neighbor cells during time gaps between paging monitoring instances of multiple paging sources, or time gaps between UE activities for different signal sources.

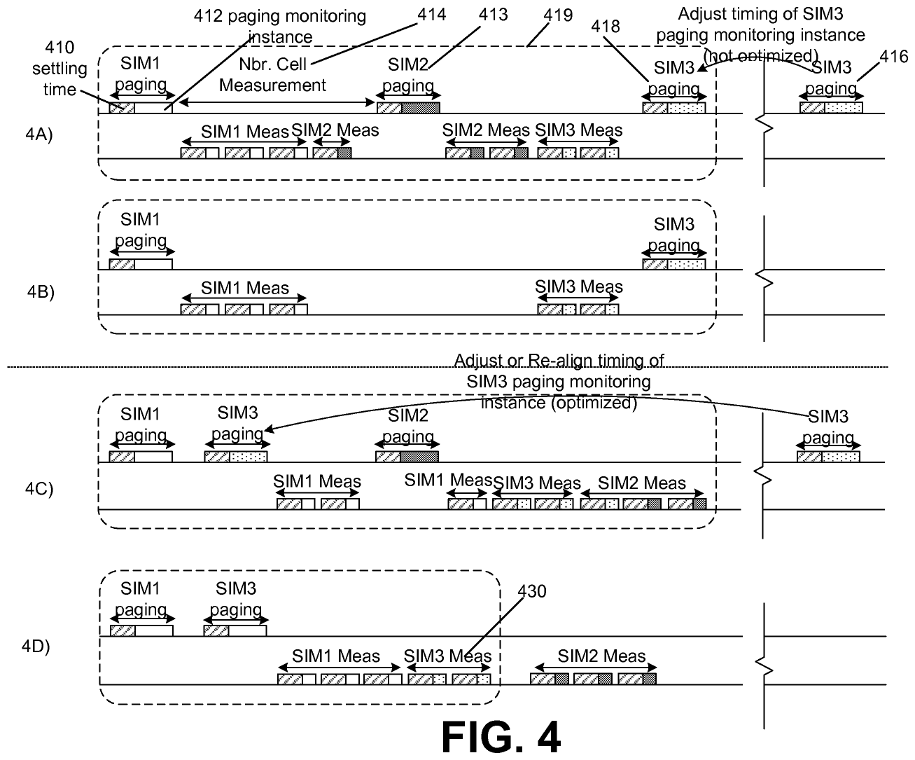

FIG. 4 is a diagram illustrating measurement of signals during time gaps between paging monitoring instances for a plurality of paging sources according to an example embodiment. FIG. 4 illustrates four cases, including cases 4A), 4B), 4C) and 4D). In FIG. 4, paging monitoring instances are shown for three SIMs (or three paging sources, e.g., different network nodes), e.g., including SIM1, SIM2, and SIM3. In this illustrative example, SIM1 and SIM3 have short (or shorter) paging cycles (DRX cycles), and SIM2 has a long (or longer) paging cycle (DRX cycles). At 4A), an example paging monitoring instance for SIM1 may include a settling time 410 (e.g., to adjust transceiver frequency, and/or apply beamforming weights, and the like to transmit or receive a signal) and a paging monitoring instance 412. Later, a SIM2 paging monitoring instance 413 occurs. At 414, the UE may perform neighbor cell signal (e.g., SSB or CSI-RS) measurement in the time gap (414) between the SIM1 paging monitoring instance 412 and the SIM2 paging monitoring instance 413. Thus, for example, at 414, the UE may measure neighbor cells with respect to the SIM1 (or paging source 1 or network node 1) and with respect to SIM2 (or paging source 2 or network node 2). These neighbor cell measurements may be reported back by the UE to the respective paging sources or network nodes. As shown in case 4A) in FIG. 4, the SIM3 paging monitoring instance is moved from location 416 to location 418 at the end of the paging cluster 419, which may be a non-optimum location or paging timing because both paging timing for SIM1 and SIM3 have a short paging cycle, and SIM2 has a long paging cycle. Thus, the location of SIM3 paging monitoring instance 418 is non-optimum since it may create a large (or unnecessarily large) gap in time between end of SIM1 paging monitoring instance 412 and beginning of SIM3 paging monitoring instance 418, when the SIM2 paging monitoring instance 413 is not present (due to having a longer paging cycle). Case 4B) in FIG. 4 shows the example where SIM2 paging monitoring instance is not shown, and SIM2 measurement is not performed by the UE, and thus, an unnecessary time gap is present between SIM1 paging monitoring instance and SIM3 paging monitoring instance. Thus, and therefore an unnecessary gap occurs when SIM1 and SIM3 need to monitor for paging and SIM2 does not (1B).

In another example, as shown in case 4C), the SIM3 paging monitoring instance is moved between SIM1 paging monitoring instance and SIM2 paging monitoring instance, which may allow the UE to transition to sleep or low power state much earlier (or to spend such time performing signal measurement) as compared to case 4B) when SIM2 paging monitoring instance is not present. The SIM3 paging occasion is moved in between the paging occasions of SIM1 and SIM2 (4C), and this allows the UE to enter sleep state early (or earlier) when only SIM1 and SIM3 have paging occasions (4D). As shown in case 4D), the UE may, for example, perform SIM3 signal measurements at 430 when SIM2 paging monitoring instance is not present.

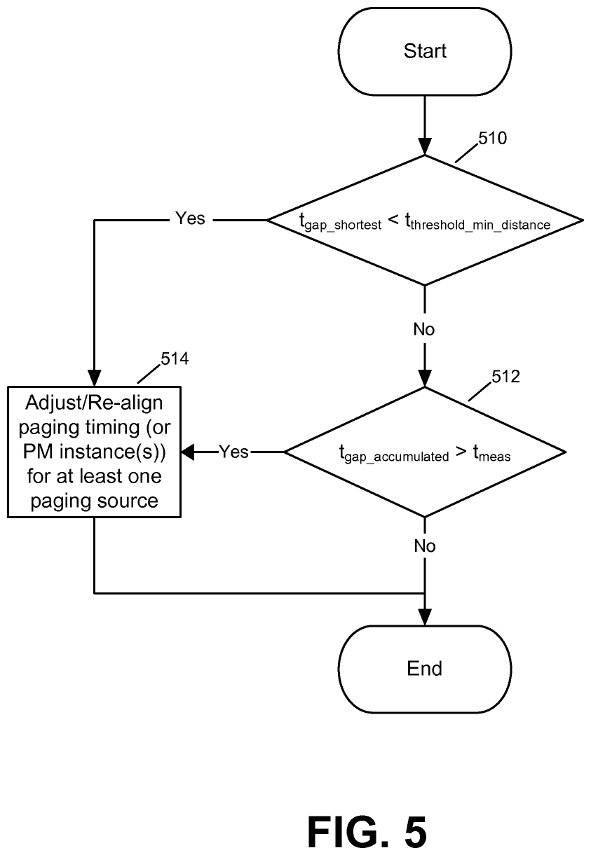

FIG. 5 is a flow chart illustrating techniques that may be used to determine when to adjust a paging timing (or UE activity period) according to example embodiment. The techniques described in FIG. 5 are example techniques and other techniques or approaches may be used.

The different parameters in the decision algorithm is explained below:
tₘₑₐₛ: Time needed for all measurements from all SIM's besides from paging reception.
t_{threshold_min_distance}: Minimum time between pagings (or between paging monitoring instances) including a margin.
t_{gap_shortest}: Shortest gap between any of the paging monitoring instances.
t_{gap_accumulated}: Accumulated Gap time between all paging monitoring instances.

The decision algorithm of FIG. 5 may be used to trigger the re-alignment or adjustment procedure (514) for a paging timing for one or more paging sources. For example, the algorithm determines if either (510) the shortest gap between any of the pagings (or paging monitoring instances) has become less than the t_{threshold_min_distance}, or if (512) the total gap duration exceeds the time needed for all the cell measurements. One or even both of these conditions can be triggered, for example, by timing drift of the networks and in that case a re-alignment or adjustment of the paging timing or timing of the paging monitoring instances may be triggered (or caused to be performed).

In an example embodiment, the paging timing adjustment or realignment procedure may begin by sorting the paging monitoring instances (or paging sources) according to the length of DRX (or paging) cycle. Paging monitoring instances with the same length of paging (or DRX) cycle may be aligned (or grouped together or grouped adjacent to each other) in a number of different orders, so this means that there may be multiple valid combinations when sorting a list of paging monitoring instances. To decide which list (or which order of paging monitoring instances) to select, the list (or order of paging monitoring instances) may be associated with a cost function. In an illustrative example, the cost function may be a number of paging monitoring instance adjustments that need to be performed to transfer from the original order of paging monitoring instances to the new order of paging monitoring instances. The list with the lowest cost is then the list selected for rearranging the PO's.

An example procedure may include:
1. Find multiple (or even all) valid combinations of paging monitoring instances (or paging timings) sorted according to the length of paging or DRX cycle. Paging timings with a same length of paging cycle will generate multiple valid combinations.
2. Select the combination (or one of the combinations) of paging timings, among the multiple paging sources, which minimizes the number of paging timing or paging monitoring instances adjustments or re-alignments.
3. Ensure that all time gaps between paging monitoring instances have a duration of more than t_{threshold_min_distance}.

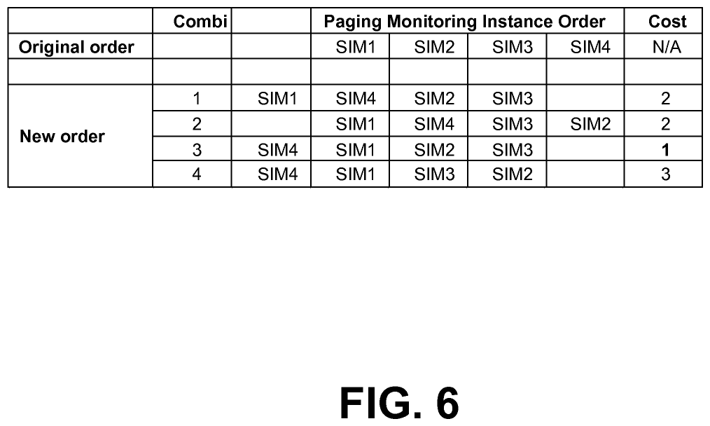

To illustrate the procedure, consider the example depicted in FIG. 2. It may be assumed, for example, that one of the trigger conditions for the adjustment or realignment procedure has been met. The actual adjustment or realignment procedure would start by finding all the paging timing or paging monitoring instance combinations (for the multiple paging sources) which has a valid and possibly an optimal (least cost) sorting according to the length of paging (or DRX) cycle. Since SIM1 and SIM4 have the same paging cycle length (e.g., short), and the paging cycle length of SIM2 and SIM3 are long(er), there will be 4 valid combinations as illustrated in the table illustrated in the example of FIG. 6. FIG. 6 is a table identifying four different combinations or orders of paging monitoring instances for four paging sources (SIM1, SIM2, SIM3 and SIM4) according to an example embodiment.

As shown in the table of FIG. 6, the original order of paging monitoring instances in the table of FIG. 6 is the same combination or order of paging monitoring instances shown in FIG. 2 (SIM1, SIM2, SIM3, SIM4). As noted, there are four different valid combinations or orders of paging monitoring instances, e.g., for example, which would group together the paging monitoring instances for the two short (or shorter) paging cycles (SIM1, SIM4), and group together the paging monitoring instances for the two long (or longer) paging cycles (SIM2, SIM3), and/or may provide the order of paging monitoring instances in either ascending or descending order of length of paging cycle (as some examples of valid or desirable combinations). A cost (or cost function) is shown for each combination or paging monitoring instance order, wherein in this illustrative example, the cost is the number of adjustments required to provide the valid combination or order of paging monitoring instances. Combination 1 (order of SIM1, SIM4, SIM2, SIM3) has a cost of 2 (2 paging monitoring instance timing adjustments required), and provides an order paging monitoring instances (within a time period) having increasing (or ascending) length of paging cycles. Combination 2 (order of SIM1, SIM4, SIM3, SIM2) has a cost of 2, and provides an order paging monitoring instances (within a time period) having an increasing or ascending paging cycle length. Combination 3 (order of SIM4, SIM1, SIM2, SIM3) has a cost of 1 (the lowest cost), and provide increasing or ascending paging cycle length (grouping together the paging monitoring instances for SIM1 and SIM4, followed by a grouping together of paging monitoring instances for SIM2 and SIM3). Combination 4 (order of SIM4, SIM1, SIM3, SIM2) has a cost of 3 (3 paging monitoring instance timing adjustments required), and provides an increasing or ascending paging cycle length (grouping together of paging monitoring instances for SIM1 and SIM4, followed by a grouping together of paging monitoring instances for SIM2 and SIM3. While each of these four combinations, or orders of paging monitoring instances, would provide a valid (e.g., providing decreased time gaps between paging monitoring instances, e.g., using either ascending or descending paging cycle length, and/or grouping together paging monitoring instances having a same or similar (within a threshold) paging cycle length), combination 3 (with a cost of 1, since it only requires a paging timing for only one paging source to be adjusted or rearranged) has the lowest cost of the four combination or orders of paging monitoring instances. Thus, according to an example embodiment, the UE and/or network may select a combination or order of paging monitoring instances, among a plurality of paging sources, and then request or obtain the one or more adjusted paging (or activity) timings for that combination, e.g., which may reduce and/or minimize the cost (e.g., where cost may be or include any cost function, such as for example, a number of paging timing/activity timing adjustments that may be required).

According to some aspects, there is provided the subject matter of the independent claims. Some further aspects are defined in the dependent claims. The embodiments that do not fall under the scope of the claims are to be interpreted as examples useful for understanding the disclosure.

Some further example embodiments are now described.

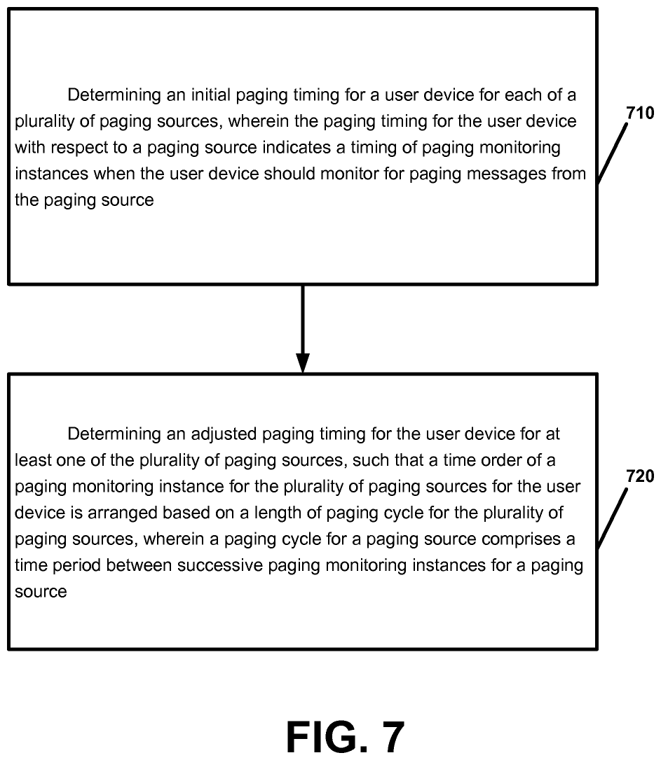

Example 1. FIG. 7 is a flow chart illustrating operation according to an example embodiment. The operations of FIG. 7 may be performed a UE, user device, or a BS/gNB or other network node or other wireless node. Operation 710 includes determining an initial paging timing for a user device for each of a plurality of paging sources, wherein the paging timing for the user device with respect to a paging source indicates a timing of paging monitoring instances when the user device should monitor for paging messages from the paging source. Operation 720 includes determining an adjusted paging timing for the user device for at least one of the plurality of paging sources, such that a time order of a paging monitoring instance for the plurality of paging sources for the user device is arranged based on a length of paging cycle for the plurality of paging sources, wherein a paging cycle for a paging source comprises a time period between successive paging monitoring instances for a paging source.

Example 2. The method of example 1, wherein a user device identity has been assigned or reassigned to the user device for one or more of the plurality of paging sources, at least for the purposes of paging.

Example 3. The method of any of examples 1-2, wherein each of the plurality of paging sources is associated with at least one of: a different wireless network; a different wireless operator; or a different radio access technology (RAT).

Example 4. The method of any of examples 1-3, wherein the determining an initial paging timing comprises: determining an initial paging timing for the user device for each of a plurality of paging sources based on at least one of system information associated with a respective paging source or a user device identity that has been assigned to the user device for a respective paging source.

Example 5. The method of any of examples 1-4, wherein the adjusted paging timing is determined such that a time order of a paging monitoring instance for the plurality of paging sources for the user device will be arranged in either descending order of length of paging cycle or ascending order of length of paging cycle for the plurality of paging sources.

Example 6. The method of any of examples 1-5 wherein the adjusted paging timing is determined such that paging monitoring instances, for the plurality of paging sources for the user device, having a same length of paging cycle will be grouped together or adjacent to each other in time, either with or without a time gap therebetween.

Example 7. The method of any of examples 1-6, wherein the determining an adjusted paging timing for the user device for at least one of the plurality of paging sources comprises: sending, by the user device to a network node, a request for an adjusted paging timing for the user device for at least one of the plurality of paging sources, such that a time order of a paging monitoring instance for the plurality of paging sources for the user device will be arranged based on a length of paging cycle for the plurality of paging sources; and receiving, by the user device from the network node in response to the request, a response including information identifying an adjusted paging timing for the user device for at least one of the paging sources.

Example 8. The method of example 7, wherein the sending a request comprises: sending, by the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 9. The method of any of examples 1-8, comprising: monitoring, by the user device based on the adjusted paging timing, one or more wireless channels for a paging message from one or more of the plurality of paging sources.

Example 10. The method of any of examples 1-9, wherein the plurality of paging sources comprise at least a first paging source having a first paging cycle, a second paging source having a second paging cycle that is different from the first paging cycle, and a third paging source having the first paging cycle that is the same as the first paging source, the determining an adjusted paging timing comprises at least: sending, by the user device to a network node, a request for an adjusted paging timing for the user device for at least the first paging source, such that an adjusted order of a paging monitoring instance for the plurality of paging sources for the user device will include a paging monitoring instance for the first paging source adjacent in time to, or grouped with, a paging monitoring instance of the third paging source.

Example 11. The method of example 10: wherein a gap in time is present between the paging monitoring instance for the third paging source and the adjusted paging monitoring instance for the first paging source based on the adjusted paging timing; and wherein, based on the adjusted paging timing, the paging monitoring instance for the second paging source is not provided between the paging monitoring instance of the first paging source and the paging monitoring instance of the third paging source.

Example 12. The method of any of examples 1-11, wherein the determining an adjusted paging timing for the user device for at least one of the plurality of paging sources comprises: receiving, by the user device, an adjusted paging timing for at least one of the plurality of paging sources based on at least one of the following: receiving, by the user device, a new user device identity, with respect to the at least one of the plurality of paging sources, that provides, or is associated with, an adjusted paging timing for the at least one of the plurality of paging sources for the user device; or receiving, by the user device, information indicating an adjusted paging timing for the at least one of the plurality of paging sources for the user device.

Example 13. A method of any of examples 1-12, further comprising: performing, by the user device, reference signal measurement for reference signals received from one or more cells during a time gap between paging monitoring instances of the plurality of paging sources.

Example 14. The method of any of examples 1-6: wherein the determining an adjusted paging timing for the user device for at least one of the plurality of paging sources comprises: receiving, by a network node from the user device, a request for an adjusted paging timing for the user device for at least one of the plurality of paging sources; determining, by the network node, an adjusted paging timing for the user device for at least one of the plurality of paging sources, such that a time order of paging monitoring instances for the user device for the plurality of paging sources will be arranged based on a length of paging cycle for the plurality of paging sources; and sending, by the network node to the user device in response to the request, a response including information identifying the adjusted paging timing for at least one of the paging sources for the user device.

Example 15. The method of example 14, wherein the receiving a request comprises: receiving, by the network node from the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 16. The method of any of examples 1-6 and 14-15: wherein the determining an initial paging timing comprises determining an initial paging timing for each of a plurality of paging sources for the user device based on one or more of the following: a requested paging timing, indicated in a request received from the user device, for the user device with respect to at least one of the plurality of paging sources; and/or information indicating, or at least related to, the initial paging timing for one or more of the plurality of paging sources for the user device.

Example 17. The method of any of examples 1-6 and 14-16, wherein the determining an adjusted paging timing comprises: determining, by the network node, an adjusted paging timing for at least one of the plurality of paging sources for the user device, such that a time order of paging monitoring instances for the user device for the plurality of paging sources will be arranged based on a length of paging cycle for the plurality of paging sources.

Example 18. The method of example 14, wherein the request includes at least one of: a requested paging timing for the user device for at least one of the paging sources; or current paging timing information for the user device for at least one of the plurality of paging sources.

Example 19. The method of any of examples 1-6 and 14-18, further comprising: sending, by the network node to the user device, a response with respect to the at least one of the paging sources, wherein the response includes information identifying an adjusted paging timing for at least one of the paging sources for the user device.

Example 20. An apparatus comprising means for performing the method of any of examples 1-19.

Example 21. A non-transitory computer-readable storage medium comprising instructions stored thereon that, when executed by at least one processor, are configured to cause a computing system to perform the method of any of examples 1-19.

Example 22. An apparatus comprising: at least one processor; and at least one memory including computer program code; the at least one memory and the computer program code configured to, with the at least one processor, cause the apparatus at least to perform the method of any of examples 1-19.

Example 23. A method comprises determining an initial paging timing for a user device for each of a plurality of paging sources, wherein the paging timing for the user device with respect to a paging source indicates a timing of paging monitoring instances when the user device should monitor for paging messages from the paging source; and, determining an adjusted paging timing for the user device for at least one of the plurality of paging sources, such that a time order of a paging monitoring instance for the plurality of paging sources for the user device is arranged based on a length of paging cycle for the plurality of paging sources, wherein a paging cycle for a paging source comprises a time period between successive paging monitoring instances for a paging source.

Example 24. The method of example 23, wherein a user device identity has been assigned or reassigned to the user device for one or more of the plurality of paging sources, at least for the purposes of paging.

Example 25. The method of example 23, wherein each of the plurality of paging sources is associated with at least one of: a different wireless network; a different wireless operator; or a different radio access technology (RAT).

Example 26. The method of any example 23, wherein the determining an initial paging timing comprises: determining an initial paging timing for the user device for each of a plurality of paging sources based on at least one of system information associated with a respective paging source or a user device identity that has been assigned to the user device for a respective paging source.

Example 27. The method of example 23, wherein the adjusted paging timing is determined such that a time order of a paging monitoring instance for the plurality of paging sources for the user device will be arranged in either descending order of length of paging cycle or ascending order of length of paging cycle for the plurality of paging sources.

Example 28. The method of example 23 wherein the adjusted paging timing is determined such that paging monitoring instances, for the plurality of paging sources for the user device, having a same length of paging cycle will be grouped together or adjacent to each other in time, either with or without a time gap therebetween.

Example 29. The method of example 23, wherein the determining an adjusted paging timing for the user device for at least one of the plurality of paging sources comprises: sending, by the user device to a network node, a request for an adjusted paging timing for the user device for at least one of the plurality of paging sources, such that a time order of a paging monitoring instance for the plurality of paging sources for the user device will be arranged based on a length of paging cycle for the plurality of paging sources; and receiving, by the user device from the network node in response to the request, a response including information identifying an adjusted paging timing for the user device for at least one of the paging sources.

Example 30. The method of example 29, wherein the sending a request comprises: sending, by the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 31. The method example 23, comprising: monitoring, by the user device based on the adjusted paging timing, one or more wireless channels for a paging message from one or more of the plurality of paging sources.

Example 32. The method of example 23, wherein the plurality of paging sources comprise at least a first paging source having a first paging cycle, a second paging source having a second paging cycle that is different from the first paging cycle, and a third paging source having the first paging cycle that is the same as the first paging source, the determining an adjusted paging timing comprises at least: sending, by the user device to a network node, a request for an adjusted paging timing for the user device for at least the first paging source, such that an adjusted order of a paging monitoring instance for the plurality of paging sources for the user device will include a paging monitoring instance for the first paging source adjacent in time to, or grouped with, a paging monitoring instance of the third paging source.

Example 33. The method of example 32: wherein a gap in time is present between the paging monitoring instance for the third paging source and the adjusted paging monitoring instance for the first paging source based on the adjusted paging timing; and wherein, based on the adjusted paging timing, the paging monitoring instance for the second paging source is not provided between the paging monitoring instance of the first paging source and the paging monitoring instance of the third paging source.

Example 34. The method of example 23, wherein the determining an adjusted paging timing for the user device for at least one of the plurality of paging sources comprises: receiving, by the user device, an adjusted paging timing for at least one of the plurality of paging sources based on at least one of the following: receiving, by the user device, a new user device identity, with respect to the at least one of the plurality of paging sources, that provides, or is associated with, an adjusted paging timing for the at least one of the plurality of paging sources for the user device; or receiving, by the user device, information indicating an adjusted paging timing for the at least one of the plurality of paging sources for the user device.

Example 35. A method of example 23, further comprising: performing, by the user device, reference signal measurement for reference signals received from one or more cells during a time gap between paging monitoring instances of the plurality of paging sources.

Example 36. The method of example 23: wherein the determining an adjusted paging timing for the user device for at least one of the plurality of paging sources comprises: receiving, by a network node from the user device, a request for an adjusted paging timing for the user device for at least one of the plurality of paging sources; determining, by the network node, an adjusted paging timing for the user device for at least one of the plurality of paging sources, such that a time order of paging monitoring instances for the user device for the plurality of paging sources will be arranged based on a length of paging cycle for the plurality of paging sources; and sending, by the network node to the user device in response to the request, a response including information identifying the adjusted paging timing for at least one of the paging sources for the user device.

Example 37. The method of example 36, wherein the receiving a request comprises: receiving, by the network node from the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 38. The method of example 23: wherein the determining an initial paging timing comprises determining an initial paging timing for each of a plurality of paging sources for the user device based on one or more of the following: a requested paging timing, indicated in a request received from the user device, for the user device with respect to at least one of the plurality of paging sources; and/or information indicating, or at least related to, the initial paging timing for one or more of the plurality of paging sources for the user device.

Example 39. The method of example 23, wherein the determining an adjusted paging timing comprises: determining, by the network node, an adjusted paging timing for at least one of the plurality of paging sources for the user device, such that a time order of paging monitoring instances for the user device for the plurality of paging sources will be arranged based on a length of paging cycle for the plurality of paging sources.

Example 40. The method of example 39, wherein the request includes at least one of: a requested paging timing for the user device for at least one of the paging sources; or current paging timing information for the user device for at least one of the plurality of paging sources.

Example 41. The method of example 40, further comprising: sending, by the network node to the user device, a response with respect to the at least one of the paging sources, wherein the response includes information identifying an adjusted paging timing for at least one of the paging sources for the user device.

Example 42. An apparatus comprising means for performing the method of example 23.

Example 43. A non-transitory computer-readable storage medium comprising instructions stored thereon that, when executed by at least one processor, are configured to cause a computing system to perform the method of example 23.

Example 44. An apparatus comprising: at least one processor; and at least one memory including computer program code; the at least one memory and the computer program code configured to, with the at least one processor, cause the apparatus at least to perform the method of example 23.

Example 45. An apparatus comprising: at least one processor; and at least one memory including computer program code; the at least one memory and the computer program code configured to, with the at least one processor, cause the apparatus at least to: determine an initial paging timing for a user device for each of a plurality of paging sources, wherein the paging timing for the user device with respect to a paging source indicates a timing of paging monitoring instances when the user device should monitor for paging messages from the paging source, and determine an adjusted paging timing for the user device for at least one of the plurality of paging sources, such that a time order of a paging monitoring instance for the plurality of paging sources for the user device is arranged based on a length of paging cycle for the plurality of paging sources, wherein a paging cycle for a paging source comprises a time period between successive paging monitoring instances for a paging source.

Example 46. The apparatus of example 45, wherein a user device identity has been assigned or reassigned to the user device for one or more of the plurality of paging sources, at least for the purposes of paging.

Example 47. The apparatus of example 45, wherein each of the plurality of paging sources is associated with at least one of: a different wireless network; a different wireless operator; or a different radio access technology (RAT).

Example 48. The apparatus of example 45, wherein causing the apparatus to determine an initial paging timing comprises: causing the apparatus to determine an initial paging timing for the user device for each of a plurality of paging sources based on at least one of system information associated with a respective paging source or a user device identity that has been assigned to the user device for a respective paging source.

Example 49. The apparatus of example 45, wherein the adjusted paging timing is determined such that a time order of a paging monitoring instance for the plurality of paging sources for the user device will be arranged in either descending order of length of paging cycle or ascending order of length of paging cycle for the plurality of paging sources.

Example 50. The apparatus of example 45, wherein the adjusted paging timing is determined such that paging monitoring instances, for the plurality of paging sources for the user device, having a same length of paging cycle will be grouped together or adjacent to each other in time, either with or without a time gap therebetween.

Example 51. The apparatus of example 45, wherein causing the apparatus to determine an adjusted paging timing for the user device for at least one of the plurality of paging sources comprises causing the apparatus to: send, by the user device to a network node, a request for an adjusted paging timing for the user device for at least one of the plurality of paging sources, such that a time order of a paging monitoring instance for the plurality of paging sources for the user device will be arranged based on a length of paging cycle for the plurality of paging sources; and receive, by the user device from the network node in response to the request, a response including information identifying an adjusted paging timing for the user device for at least one of the paging sources.

Example 52. The apparatus of example 51, wherein causing the apparatus to send a request comprises causing the apparatus to: send, by the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 53. The apparatus of example 45, comprising causing the apparatus to: monitor, by the user device based on the adjusted paging timing, one or more wireless channels for a paging message from one or more of the plurality of paging sources.

Example 54. The apparatus of example 45, wherein the plurality of paging sources comprise at least a first paging source having a first paging cycle, a second paging source having a second paging cycle that is different from the first paging cycle, and a third paging source having the first paging cycle that is the same as the first paging source, the causing the apparatus to determine an adjusted paging timing comprises causing the apparatus at least to: send, by the user device to a network node, a request for an adjusted paging timing for the user device for at least the first paging source, such that an adjusted order of a paging monitoring instance for the plurality of paging sources for the user device will include a paging monitoring instance for the first paging source adjacent in time to, or grouped with, a paging monitoring instance of the third paging source.

Example 55. The apparatus of example 54: wherein a gap in time is present between the paging monitoring instance for the third paging source and the adjusted paging monitoring instance for the first paging source based on the adjusted paging timing; and wherein, based on the adjusted paging timing, the paging monitoring instance for the second paging source is not provided between the paging monitoring instance of the first paging source and the paging monitoring instance of the third paging source.

Example 56. The apparatus of example 45, wherein causing the apparatus to determine an adjusted paging timing for the user device for at least one of the plurality of paging sources comprises causing the apparatus to: receive, by the user device, an adjusted paging timing for at least one of the plurality of paging sources based on at least one of the following: receiving, by the user device, a new user device identity, with respect to the at least one of the plurality of paging sources, that provides, or is associated with, an adjusted paging timing for the at least one of the plurality of paging sources for the user device; or receiving, by the user device, information indicating an adjusted paging timing for the at least one of the plurality of paging sources for the user device.

Example 57. The apparatus of example 45, further comprising causing the apparatus to: perform, by the user device, reference signal measurement for reference signals received from one or more cells during a time gap between paging monitoring instances of the plurality of paging sources.

Example 58. The apparatus of example 45: wherein causing the apparatus to determine an adjusted paging timing for the user device for at least one of the plurality of paging sources comprises causing the apparatus to: receive, by a network node from the user device, a request for an adjusted paging timing for the user device for at least one of the plurality of paging sources; determine, by the network node, an adjusted paging timing for the user device for at least one of the plurality of paging sources, such that a time order of paging monitoring instances for the user device for the plurality of paging sources will be arranged based on a length of paging cycle for the plurality of paging sources; and send, by the network node to the user device in response to the request, a response including information identifying the adjusted paging timing for at least one of the paging sources for the user device.

Example 59. The apparatus of example 58, wherein causing the apparatus to receive a request comprises causing the apparatus to: receive, by the network node from the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 60. The apparatus of example 45, wherein causing the apparatus to determine an initial paging timing comprises causing the apparatus to: determine an initial paging timing for each of a plurality of paging sources for the user device based on one or more of the following: a requested paging timing, indicated in a request received from the user device, for the user device with respect to at least one of the plurality of paging sources; and/or information indicating, or at least related to, the initial paging timing for one or more of the plurality of paging sources for the user device.

Example 61. The apparatus of example 45, wherein causing the apparatus to determine an adjusted paging timing comprises causing the apparatus to: determine, by the network node, an adjusted paging timing for at least one of the plurality of paging sources for the user device, such that a time order of paging monitoring instances for the user device for the plurality of paging sources will be arranged based on a length of paging cycle for the plurality of paging sources.

Example 62. The apparatus of example 58, wherein the request includes at least one of: a requested paging timing for the user device for at least one of the paging sources; or a current paging timing information for the user device for at least one of the plurality of paging sources.

Example 63. The apparatus of example 45, further comprising causing the apparatus to: send, by the network node to the user device, a response with respect to the at least one of the paging sources, wherein the response includes information identifying an adjusted paging timing for at least one of the paging sources for the user device.

Example 64. A non-transitory computer-readable storage medium comprising instructions stored thereon that, when executed by at least one processor, are configured to cause a computing system to determine an initial paging timing for a user device for each of a plurality of paging sources, wherein the paging timing for the user device with respect to a paging source indicates a timing of paging monitoring instances when the user device should monitor for paging messages from the paging source, and determine an adjusted paging timing for the user device for at least one of the plurality of paging sources, such that a time order of a paging monitoring instance for the plurality of paging sources for the user device is arranged based on a length of paging cycle for the plurality of paging sources, wherein a paging cycle for a paging source comprises a time period between successive paging monitoring instances for a paging source.

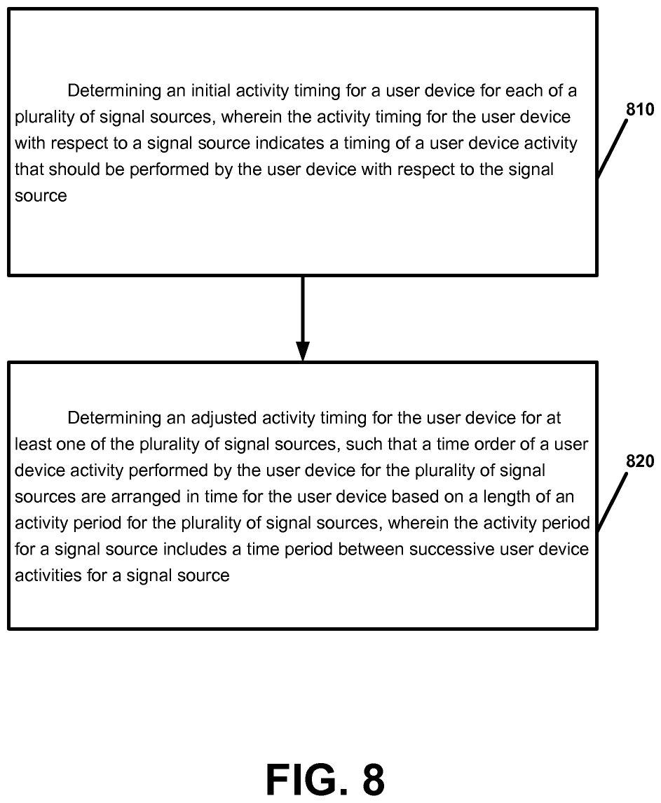

Example 65. FIG. 8 is a flow chart illustrating operation according to an example embodiment. The operations of FIG. 8 may be performed a UE, user device, or a BS/gNB or other network node or other wireless node. Operation 810 includes determining an initial activity timing for a user device for each of a plurality of signal sources, wherein the activity timing for the user device with respect to a signal source indicates a timing of a user device activity that should be performed by the user device with respect to the signal source. And, operation 820 includes determining an adjusted activity timing for the user device for at least one of the plurality of signal sources, such that a time order of a user device activity performed by the user device for the plurality of signal sources are arranged in time for the user device based on a length of an activity period for the plurality of signal sources, wherein the activity period for a signal source includes a time period between successive user device activities for a signal source.

Example 66. The method of example 65 wherein the user device activity that should be performed by the user device with respect to a signal source comprises the user device performing at least one of the following: monitoring a paging monitoring instance(s), for a paging message, from each of one or more paging sources; receiving and/or measuring reference signals from each of one or more reference signal sources; sending, by the user device, a measurement report or other information to each of one or more signal sources or network nodes; or receiving data from each of one or more data sources.

Example 67. The method of any of examples 65-66 wherein the initial activity timing for a user device for each of a plurality of signal sources comprises at least one of: an initial paging timing for a user device for each of a plurality of paging sources; an initial timing of measurement of reference signals from each of a plurality of reference signal sources; an initial timing of reporting of signal measurements to each of a plurality of signal sources or network nodes; or an initial timing to receive data from each of a plurality of data sources.

Example 68. The method of any of examples 65-67, wherein the determining an adjusted activity timing for the user device for at least one of the plurality of signal sources comprises: sending, by the user device, a request for the adjusted activity timing for at least one of the plurality of signal sources for the user device; and receiving, by the user device, a response that includes information identifying the adjusted activity timing for at least one of the plurality of signal sources for the user device.

Example 69. The method of any of examples 65-68, wherein the adjusted activity timing for the user device is determined such that a time order for the user device activity for the plurality of signal sources for the user device will be arranged in either descending order of length of activity period or ascending order of length of activity period for the plurality of signal sources.

Example 70. The method of any of examples 65-69 wherein the adjusted activity timing is determined such that user device activities, for the plurality of signal sources for the user device, having a same length of activity period, will be grouped together or adjacent to each other in time, either with or without a time gap therebetween.

Example 71. The method of any of examples 65-70, comprising: estimating a power savings that the user device will obtain based on the adjusted activity timing for the user device for the at least one of the plurality of signal sources. This operation of example 71 may be performed, for example, by a UE/user device, a gNB/BS, or another node or external entity. As an example, prior to requesting a specific adjusting activity timing from or with respect to one or more signal sources, the UE, gNB/BS, or other node or entity may determine or estimate the power saving that may result for the UE based on this requested adjusted activity timing. Estimated power savings may be estimated for one or more adjusted activity timings, and then the UE may request (or the gNB/BS may provide to the UE) the adjusted activity timing for one or more signal sources so that the UE will obtain the estimated power savings. Thus, an adjusted activity timing(s) may be selected that may provide the UE with a higher (or even the highest) power savings. Also, for example, a UE/user device or BS/gNB or other node may estimate a net power savings that will be (or was) obtained by the UE/user device over a period of time, e.g., which may take into account both the additional power cost (cost function) of the user device/UE to determine or obtain an adjusted activity timing for the user device for at least one of the signal sources, as compared to the power savings for the UE/user device based on a new time arrangement of user device activities for the plurality of signal sources. Thus, the estimated power savings may be determined in advance, before the obtaining and/or use of the adjusted activity timing, or may be measured over time based on actual activities or power usage or power savings of the UE that is based on the adjusted activity timing(s).

Example 72. The method of any of claims 65-71, wherein: the determining an initial activity timing for a user device for each of a plurality of signal sources comprises: determining an initial paging timing for a user device for each of a plurality of paging sources, wherein the paging timing for the user device with respect to a paging source indicates a timing of paging monitoring instances when the user device should monitor for paging messages from the paging source; and the determining an adjusted activity timing for the user device for at least one of the plurality of signal sources comprises: determining an adjusted paging timing for the user device for at least one of the plurality of paging sources, such that a time order of a paging monitoring instance for the plurality of paging sources for the user device is arranged based on a length of paging cycle for the plurality of paging sources, wherein a paging cycle for a paging source comprises a time period between successive paging monitoring instances for a paging source.

Example 73. The method of example 72, wherein a user device identity has been assigned or reassigned to the user device for one or more of the plurality of paging sources, at least for the purposes of paging.

Example 74. The method of any of examples 72-73, wherein each of the plurality of paging sources is associated with at least one of: a different wireless network; a different wireless operator; or a different radio access technology (RAT).

Example 75. The method of any of examples 72-74, wherein the determining an initial paging timing comprises: determining an initial paging timing for the user device for each of a plurality of paging sources based on at least one of system information associated with a respective paging source or a user device identity that has been assigned to the user device for a respective paging source.

Example 76. The method of any of examples 72-75, wherein the adjusted paging timing is determined such that a time order of a paging monitoring instance for the plurality of paging sources for the user device will be arranged in either descending order of length of paging cycle or ascending order of length of paging cycle for the plurality of paging sources.

Example 77. The method of any of examples 72-76 wherein the adjusted paging timing is determined such that paging monitoring instances, for the plurality of paging sources for the user device, having a same length of paging cycle will be grouped together or adjacent to each other in time, either with or without a time gap therebetween.

Example 78. The method of any of examples 72-77, wherein the determining an adjusted paging timing for the user device for at least one of the plurality of paging sources comprises: sending, by the user device to a network node, a request for an adjusted paging timing for the user device for at least one of the plurality of paging sources, such that a time order of a paging monitoring instance for the plurality of paging sources for the user device will be arranged based on a length of paging cycle for the plurality of paging sources; and receiving, by the user device from the network node in response to the request, a response including information identifying an adjusted paging timing for the user device for at least one of the paging sources.

Example 79. The method of example 78, wherein the sending a request comprises: sending, by the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 80. The method of any of examples 72-79, comprising: monitoring, by the user device based on the adjusted paging timing, one or more wireless channels for a paging message from one or more of the plurality of paging sources.

Example 81. The method of any of examples 72-80, wherein the plurality of paging sources comprise at least a first paging source having a first paging cycle, a second paging source having a second paging cycle that is different from the first paging cycle, and a third paging source having the first paging cycle that is the same as the first paging source, the determining an adjusted paging timing comprises at least: sending, by the user device to a network node, a request for an adjusted paging timing for the user device for at least the first paging source, such that an adjusted order of a paging monitoring instance for the plurality of paging sources for the user device will include a paging monitoring instance for the first paging source adjacent in time to, or grouped with, a paging monitoring instance of the third paging source.

Example 82. The method of example 81: wherein a gap in time is present between the paging monitoring instance for the third paging source and the adjusted paging monitoring instance for the first paging source based on the adjusted paging timing; and wherein, based on the adjusted paging timing, the paging monitoring instance for the second paging source is not provided between the paging monitoring instance of the first paging source and the paging monitoring instance of the third paging source.

Example 83. The method of any of examples 65-82, wherein the determining an adjusted paging timing for the user device for at least one of the plurality of paging sources comprises: receiving, by the user device, an adjusted paging timing for at least one of the plurality of paging sources based on at least one of the following: receiving, by the user device, a new user device identity, with respect to the at least one of the plurality of paging sources, that provides, or is associated with, an adjusted paging timing for the at least one of the plurality of paging sources for the user device; or receiving, by the user device, information indicating an adjusted paging timing for the at least one of the plurality of paging sources for the user device.

Example 84. A method of any of examples 65-83, further comprising: performing, by the user device, reference signal measurement for reference signals received from one or more cells during a time gap between paging monitoring instances of the plurality of paging sources.

Example 85. The method of any of examples 65-77: wherein the determining an adjusted paging timing for the user device for at least one of the plurality of paging sources comprises: receiving, by a network node from the user device, a request for an adjusted paging timing for the user device for at least one of the plurality of paging sources; determining, by the network node, an adjusted paging timing for the user device for at least one of the plurality of paging sources, such that a time order of paging monitoring instances for the user device for the plurality of paging sources will be arranged based on a length of paging cycle for the plurality of paging sources; and sending, by the network node to the user device in response to the request, a response including information identifying the adjusted paging timing for at least one of the paging sources for the user device.

Example 86. The method of example 85, wherein the receiving a request comprises: receiving, by the network node from the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 87. The method of any of examples 85-86, wherein the determining an adjusted paging timing comprises: determining, by the network node, an adjusted paging timing for at least one of the plurality of paging sources for the user device, such that a time order of paging monitoring instances for the user device for the plurality of paging sources will be arranged based on a length of paging cycle for the plurality of paging sources.

Example 88. The method of claim 87, wherein the request includes at least one of: a requested paging timing for the user device for at least one of the paging sources; or current paging timing information for the user device for at least one of the plurality of paging sources.

Example 89. An apparatus comprising means for performing the method of any of examples 65-88.

Example 90. A non-transitory computer-readable storage medium comprising instructions stored thereon that, when executed by at least one processor, are configured to cause a computing system to perform the method of any of examples 65-88.

Example 91. An apparatus comprising: at least one processor; and at least one memory including computer program code; the at least one memory and the computer program code configured to, with the at least one processor, cause the apparatus at least to perform the method of any of examples 65-88.

Example 92. A method may include determining an initial activity timing for a user device for each of a plurality of signal sources, wherein the activity timing for the user device with respect to a signal source indicates a timing of a user device activity that should be performed by the user device with respect to the signal source; and, determining an adjusted activity timing for the user device for at least one of the plurality of signal sources, such that a time order of a user device activity performed by the user device for the plurality of signal sources are arranged in time for the user device based on a length of an activity period for the plurality of signal sources, wherein the activity period for a signal source includes a time period between successive user device activities for a signal source.

Example 93. The method of example 92 wherein the user device activity that should be performed by the user device with respect to a signal source comprises the user device performing at least one of the following: monitoring a paging monitoring instance(s), for a paging message, from each of one or more paging sources; receiving and/or measuring reference signals from each of one or more reference signal sources; sending, by the user device, a measurement report or other information to each of one or more signal sources or network nodes; or receiving data from each of one or more data sources.

Example 94. The method of example 92 wherein the initial activity timing for a user device for each of a plurality of signal sources comprises at least one of: an initial paging timing for a user device for each of a plurality of paging sources; an initial timing of measurement of reference signals from each of a plurality of reference signal sources; an initial timing of reporting of signal measurements to each of a plurality of signal sources or network nodes; or an initial timing to receive data from each of a plurality of data sources.

Example 95. The method of example 92, wherein the determining an adjusted activity timing for the user device for at least one of the plurality of signal sources comprises: sending, by the user device, a request for the adjusted activity timing for at least one of the plurality of signal sources for the user device; and receiving, by the user device, a response that includes information identifying the adjusted activity timing for at least one of the plurality of signal sources for the user device.

Example 96. The method of example 92, wherein the adjusted activity timing for the user device is determined such that a time order for the user device activity for the plurality of signal sources for the user device will be arranged in either descending order of length of activity period or ascending order of length of activity period for the plurality of signal sources.

Example 97. The method of example 92 wherein the adjusted activity timing is determined such that user device activities, for the plurality of signal sources for the user device, having a same length of activity period, will be grouped together or adjacent to each other in time, either with or without a time gap therebetween.

Example 98. The method of example 92, comprising: estimating a power savings that the user device will obtain based on the adjusted activity timing for the user device for the at least one of the plurality of signal sources. This operation of example 98 may be performed, for example, by a UE/user device, a gNB/BS, or another node or external entity. As an example, prior to requesting a specific adjusting activity timing from or with respect to one or more signal sources, the UE, gNB/BS, or other node or entity may determine or estimate the power saving that may result for the UE based on this requested adjusted activity timing. Estimated power savings may be estimated for one or more adjusted activity timings, and then the UE may request (or the gNB/BS may provide to the UE) the adjusted activity timing for one or more signal sources so that the UE will obtain the estimated power savings. Thus, an adjusted activity timing(s) may be selected that may provide the UE with a higher (or even the highest) power savings. Also, for example, a UE/user device or BS/gNB or other node may estimate a net power savings that will be (or was) obtained by the UE/user device over a period of time, e.g., which may take into account both the additional power cost (cost function) of the user device/UE to determine or obtain an adjusted activity timing for the user device for at least one of the signal sources, as compared to the power savings for the UE/user device based on a new time arrangement of user device activities for the plurality of signal sources. Thus, the estimated power savings may be determined in advance, before the obtaining and/or use of the adjusted activity timing, or may be measured over time based on actual activities or power usage or power savings of the UE that is based on the adjusted activity timing(s).

Example 99. The method example 92, wherein: the determining an initial activity timing for a user device for each of a plurality of signal sources comprises: determining an initial paging timing for a user device for each of a plurality of paging sources, wherein the paging timing for the user device with respect to a paging source indicates a timing of paging monitoring instances when the user device should monitor for paging messages from the paging source; and the determining an adjusted activity timing for the user device for at least one of the plurality of signal sources comprises: determining an adjusted paging timing for the user device for at least one of the plurality of paging sources, such that a time order of a paging monitoring instance for the plurality of paging sources for the user device is arranged based on a length of paging cycle for the plurality of paging sources, wherein a paging cycle for a paging source comprises a time period between successive paging monitoring instances for a paging source.

Example 100. The method of example 99, wherein a user device identity has been assigned or reassigned to the user device for one or more of the plurality of paging sources, at least for the purposes of paging.

Example 101. The method of example 99, wherein each of the plurality of paging sources is associated with at least one of: a different wireless network; a different wireless operator; or a different radio access technology (RAT).

Example 102. The method of example 99, wherein the determining an initial paging timing comprises: determining an initial paging timing for the user device for each of a plurality of paging sources based on at least one of system information associated with a respective paging source or a user device identity that has been assigned to the user device for a respective paging source.

Example 103. The method of example 99, wherein the adjusted paging timing is determined such that a time order of a paging monitoring instance for the plurality of paging sources for the user device will be arranged in either descending order of length of paging cycle or ascending order of length of paging cycle for the plurality of paging sources.

Example 104. The method of example 99 wherein the adjusted paging timing is determined such that paging monitoring instances, for the plurality of paging sources for the user device, having a same length of paging cycle will be grouped together or adjacent to each other in time, either with or without a time gap therebetween.

Example 105. The method of example 99, wherein the determining an adjusted paging timing for the user device for at least one of the plurality of paging sources comprises: sending, by the user device to a network node, a request for an adjusted paging timing for the user device for at least one of the plurality of paging sources, such that a time order of a paging monitoring instance for the plurality of paging sources for the user device will be arranged based on a length of paging cycle for the plurality of paging sources; and receiving, by the user device from the network node in response to the request, a response including information identifying an adjusted paging timing for the user device for at least one of the paging sources.

Example 106. The method of example 105, wherein the sending a request comprises: sending, by the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 107. The method of example 99, comprising: monitoring, by the user device based on the adjusted paging timing, one or more wireless channels for a paging message from one or more of the plurality of paging sources.

Example 108. The method of example 99, wherein the plurality of paging sources comprise at least a first paging source having a first paging cycle, a second paging source having a second paging cycle that is different from the first paging cycle, and a third paging source having the first paging cycle that is the same as the first paging source, the determining an adjusted paging timing comprises at least: sending, by the user device to a network node, a request for an adjusted paging timing for the user device for at least the first paging source, such that an adjusted order of a paging monitoring instance for the plurality of paging sources for the user device will include a paging monitoring instance for the first paging source adjacent in time to, or grouped with, a paging monitoring instance of the third paging source.

Example 109. The method of example 108: wherein a gap in time is present between the paging monitoring instance for the third paging source and the adjusted paging monitoring instance for the first paging source based on the adjusted paging timing; and wherein, based on the adjusted paging timing, the paging monitoring instance for the second paging source is not provided between the paging monitoring instance of the first paging source and the paging monitoring instance of the third paging source.

Example 110. The method of example 99, wherein the determining an adjusted paging timing for the user device for at least one of the plurality of paging sources comprises: receiving, by the user device, an adjusted paging timing for at least one of the plurality of paging sources based on at least one of the following: receiving, by the user device, a new user device identity, with respect to the at least one of the plurality of paging sources, that provides, or is associated with, an adjusted paging timing for the at least one of the plurality of paging sources for the user device; or receiving, by the user device, information indicating an adjusted paging timing for the at least one of the plurality of paging sources for the user device.

Example 111. A method of example 99, further comprising: performing, by the user device, reference signal measurement for reference signals received from one or more cells during a time gap between paging monitoring instances of the plurality of paging sources.

Example 112. The method of example 99: wherein the determining an adjusted paging timing for the user device for at least one of the plurality of paging sources comprises: receiving, by a network node from the user device, a request for an adjusted paging timing for the user device for at least one of the plurality of paging sources; determining, by the network node, an adjusted paging timing for the user device for at least one of the plurality of paging sources, such that a time order of paging monitoring instances for the user device for the plurality of paging sources will be arranged based on a length of paging cycle for the plurality of paging sources; and sending, by the network node to the user device in response to the request, a response including information identifying the adjusted paging timing for at least one of the paging sources for the user device.

Example 113. The method of example 112, wherein the receiving a request comprises: receiving, by the network node from the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 114. The method example 112, wherein the determining an adjusted paging timing comprises: determining, by the network node, an adjusted paging timing for at least one of the plurality of paging sources for the user device, such that a time order of paging monitoring instances for the user device for the plurality of paging sources will be arranged based on a length of paging cycle for the plurality of paging sources.

Example 115. The method of claim 114 wherein the request includes at least one of: a requested paging timing for the user device for at least one of the paging sources; or current paging timing information for the user device for at least one of the plurality of paging sources.

Example 116. An apparatus comprising: at least one processor; and at least one memory including computer program code; the at least one memory and the computer program code configured to, with the at least one processor, cause the apparatus at least to: determine an initial activity timing for a user device for each of a plurality of signal sources, wherein the activity timing for the user device with respect to a signal source indicates a timing of a user device activity that should be performed by the user device with respect to the signal source; and determine an adjusted activity timing for the user device for at least one of the plurality of signal sources, such that a time order of a user device activity performed by the user device for the plurality of signal sources are arranged in time for the user device based on a length of an activity period for the plurality of signal sources, wherein the activity period for a signal source includes a time period between successive user device activities for a signal source.

Example 117. The apparatus of example 116 wherein the user device activity that should be performed by the user device with respect to a signal source comprises the user device performing at least one of the following: monitoring a paging monitoring instance(s), for a paging message, from each of one or more paging sources; receiving and/or measuring reference signals from each of one or more reference signal sources; sending, by the user device, a measurement report or other information to each of one or more signal sources or network nodes; or receiving data from each of one or more data sources.

Example 118. The apparatus of example 116 wherein the initial activity timing for a user device for each of a plurality of signal sources comprises at least one of: an initial paging timing for a user device for each of a plurality of paging sources; an initial timing of measurement of reference signals from each of a plurality of reference signal sources; an initial timing of reporting of signal measurements to each of a plurality of signal sources or network nodes; or an initial timing to receive data from each of a plurality of data sources.

Example 119. The apparatus of example 116, wherein being configured to cause the apparatus to determine an adjusted activity timing for the user device for at least one of the plurality of signal sources comprises being configured to cause the apparatus to: send, by the user device, a request for the adjusted activity timing for at least one of the plurality of signal sources for the user device; and receiving, by the user device, a response that includes information identifying the adjusted activity timing for at least one of the plurality of signal sources for the user device.

Example 120. The apparatus of example 116, wherein the adjusted activity timing for the user device is determined such that a time order for the user device activity for the plurality of signal sources for the user device will be arranged in either descending order of length of activity period or ascending order of length of activity period for the plurality of signal sources.

Example 121. The apparatus of example 116 wherein the adjusted activity timing is determined such that user device activities, for the plurality of signal sources for the user device, having a same length of activity period, will be grouped together or adjacent to each other in time, either with or without a time gap therebetween.

Example 122. The apparatus of example 116, comprising: being configured to cause the apparatus to estimate a power savings that the user device will obtain based on the adjusted activity timing for the user device for the at least one of the plurality of signal sources.

Example 123. The apparatus of example 116, wherein: being configured to cause the apparatus to determine an initial activity timing for a user device for each of a plurality of signal sources comprises being configured to cause the apparatus to: determine an initial paging timing for a user device for each of a plurality of paging sources, wherein the paging timing for the user device with respect to a paging source indicates a timing of paging monitoring instances when the user device should monitor for paging messages from the paging source; and the being configured to cause the apparatus to determine an adjusted activity timing for the user device for at least one of the plurality of signal sources comprises being configured to cause the apparatus to: determine an adjusted paging timing for the user device for at least one of the plurality of paging sources, such that a time order of a paging monitoring instance for the plurality of paging sources for the user device is arranged based on a length of paging cycle for the plurality of paging sources, wherein a paging cycle for a paging source comprises a time period between successive paging monitoring instances for a paging source.

Example 124. The apparatus of example 123, wherein a user device identity has been assigned or reassigned to the user device for one or more of the plurality of paging sources, at least for the purposes of paging.

Example 125. The apparatus of example 123, wherein each of the plurality of paging sources is associated with at least one of: a different wireless network; a different wireless operator; or a different radio access technology (RAT).

Example 126. The apparatus of example 123, wherein being configured to cause the apparatus to determine an initial paging timing comprises being configured to cause the apparatus to: determine an initial paging timing for the user device for each of a plurality of paging sources based on at least one of system information associated with a respective paging source or a user device identity that has been assigned to the user device for a respective paging source.

Example 127. The apparatus of example 123, wherein the adjusted paging timing is determined such that a time order of a paging monitoring instance for the plurality of paging sources for the user device will be arranged in either descending order of length of paging cycle or ascending order of length of paging cycle for the plurality of paging sources.

Example 128. The apparatus of example 123 wherein the adjusted paging timing is determined such that paging monitoring instances, for the plurality of paging sources for the user device, having a same length of paging cycle will be grouped together or adjacent to each other in time, either with or without a time gap therebetween.

Example 129. The apparatus of any example 123, wherein being configured to cause the apparatus to determine an adjusted paging timing for the user device for at least one of the plurality of paging sources comprises being configured to cause the apparatus to: send, by the user device to a network node, a request for an adjusted paging timing for the user device for at least one of the plurality of paging sources, such that a time order of a paging monitoring instance for the plurality of paging sources for the user device will be arranged based on a length of paging cycle for the plurality of paging sources; and being configured to cause the apparatus to receive, by the user device from the network node in response to the request, a response including information identifying an adjusted paging timing for the user device for at least one of the paging sources.

Example 130. The apparatus of example 129, wherein the being configured to cause the apparatus to send a request comprises being configured to cause the apparatus to: send, by the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 131. The apparatus of example 123, comprising being configured to cause the apparatus to: monitor, by the user device based on the adjusted paging timing, one or more wireless channels for a paging message from one or more of the plurality of paging sources.

Example 132. The apparatus of example 123, wherein the plurality of paging sources comprise at least a first paging source having a first paging cycle, a second paging source having a second paging cycle that is different from the first paging cycle, and a third paging source having the first paging cycle that is the same as the first paging source, the being configured to cause the apparatus to determine an adjusted paging timing comprises at least being configured to cause the apparatus to: send, by the user device to a network node, a request for an adjusted paging timing for the user device for at least the first paging source, such that an adjusted order of a paging monitoring instance for the plurality of paging sources for the user device will include a paging monitoring instance for the first paging source adjacent in time to, or grouped with, a paging monitoring instance of the third paging source.

Example 133. The apparatus of example 132: wherein a gap in time is present between the paging monitoring instance for the third paging source and the adjusted paging monitoring instance for the first paging source based on the adjusted paging timing; and wherein, based on the adjusted paging timing, the paging monitoring instance for the second paging source is not provided between the paging monitoring instance of the first paging source and the paging monitoring instance of the third paging source.

Example 134. The apparatus of example 123, wherein the being configured to cause the apparatus to determine an adjusted paging timing for the user device for at least one of the plurality of paging sources comprises being configured to cause the apparatus to: receive, by the user device, an adjusted paging timing for at least one of the plurality of paging sources based on at least one of the following: receiving, by the user device, a new user device identity, with respect to the at least one of the plurality of paging sources, that provides, or is associated with, an adjusted paging timing for the at least one of the plurality of paging sources for the user device; or receiving, by the user device, information indicating an adjusted paging timing for the at least one of the plurality of paging sources for the user device.

Example 135. The apparatus of example 123, further comprising being configured to cause the apparatus to: perform, by the user device, reference signal measurement for reference signals received from one or more cells during a time gap between paging monitoring instances of the plurality of paging sources.

Example 136. The method of example 123: wherein the being configured to cause the apparatus to determine an adjusted paging timing for the user device for at least one of the plurality of paging sources comprises being configured to cause the apparatus to: receive, by a network node from the user device, a request for an adjusted paging timing for the user device for at least one of the plurality of paging sources; being configured to cause the apparatus to determine, by the network node, an adjusted paging timing for the user device for at least one of the plurality of paging sources, such that a time order of paging monitoring instances for the user device for the plurality of paging sources will be arranged based on a length of paging cycle for the plurality of paging sources; and being configured to cause the apparatus to send, by the network node to the user device in response to the request, a response including information identifying the adjusted paging timing for at least one of the paging sources for the user device.

Example 137. The apparatus of example 136, wherein the being configured to cause the apparatus to receive a request comprises being configured to cause the apparatus to: receive, by the network node from the user device, a request for an adjusted paging timing for the user device for a first paging source of the plurality of paging sources, wherein the request includes at least one of: a requested paging timing for the user device with respect to the first paging source; and/or information indicating, or at least related to, the initial paging timing for the user device for one or more of the plurality of paging sources.

Example 138. The apparatus of example 136, wherein the being configured to cause the apparatus to determine an adjusted paging timing comprises: being configured to cause the apparatus to determine, by the network node, an adjusted paging timing for at least one of the plurality of paging sources for the user device, such that a time order of paging monitoring instances for the user device for the plurality of paging sources will be arranged based on a length of paging cycle for the plurality of paging sources.

Example 139. The apparatus of claim 138, wherein the request includes at least one of: a requested paging timing for the user device for at least one of the paging sources; or current paging timing information for the user device for at least one of the plurality of paging sources.

Example 140. A non-transitory computer-readable storage medium comprising instructions stored thereon that, when executed by at least one processor, are configured to cause a computing system to determine an initial activity timing for a user device for each of a plurality of signal sources, wherein the activity timing for the user device with respect to a signal source indicates a timing of a user device activity that should be performed by the user device with respect to the signal source; and determine an adjusted activity timing for the user device for at least one of the plurality of signal sources, such that a time order of a user device activity performed by the user device for the plurality of signal sources are arranged in time for the user device based on a length of an activity period for the plurality of signal sources, wherein the activity period for a signal source includes a time period between successive user device activities for a signal source.

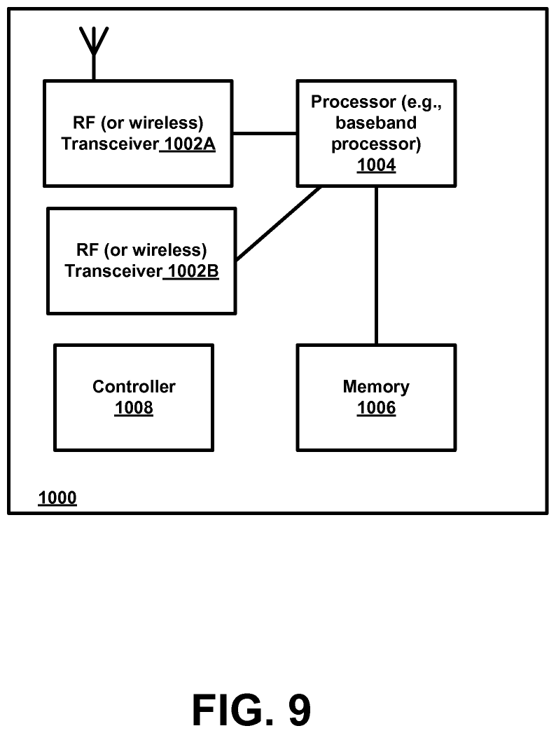

FIG. 9 is a block diagram of a wireless station or wireless node (e.g., AP, BS, gNB, user device, UE, or other network node or wireless node) 1000 according to an example embodiment. The wireless station 1000 may include, for example, one or two RF (radio frequency) or wireless transceivers 1002A, 1002B, where each wireless transceiver includes a transmitter to transmit signals and a receiver to receive signals. The wireless station also includes a processor or control unit/entity (controller) 1004 to execute instructions or software and control transmission and receptions of signals, and a memory 1006 to store data and/or instructions.

Processor 1004 may also make decisions or determinations, generate frames, packets or messages for transmission, decode received frames or messages for further processing, and other tasks or functions described herein. Processor 1004, which may be a baseband processor, for example, may generate messages, packets, frames or other signals for transmission via wireless transceiver 1002 (1002A or 1002B). Processor 1004 may control transmission of signals or messages over a wireless network, and may control the reception of signals or messages, etc., via a wireless network (e.g., after being down-converted by wireless transceiver 1002, for example). Processor 1004 may be programmable and capable of executing software or other instructions stored in memory or on other computer media to perform the various tasks and functions described above, such as one or more of the tasks or methods described above. Processor 1004 may be (or may include), for example, hardware, programmable logic, a programmable processor that executes software or firmware, and/or any combination of these. Using other terminology, processor 1004 and transceiver 1002 together may be considered as a wireless transmitter/receiver system, for example.

In addition, referring to FIG. 9, a controller (or processor) 1008 may execute software and instructions, and may provide overall control for the station 1000, and may provide control for other systems not shown in FIG. 9, such as controlling input/output devices (e.g., display, keypad), and/or may execute software for one or more applications that may be provided on wireless station 1000, such as, for example, an email program, audio/video applications, a word processor, a Voice over IP application, or other application or software.

In addition, a storage medium may be provided that includes stored instructions, which when executed by a controller or processor may result in the processor 1004, or other controller or processor, performing one or more of the functions or tasks described above.

According to another example embodiment, RF or wireless transceiver(s) 1002A/1002B may receive signals or data and/or transmit or send signals or data. Processor 1004 (and possibly transceivers 1002A/1002B) may control the RF or wireless transceiver 1002A or 1002B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. An apparatus comprising:
at least one processor; and
at least one memory including computer program code;
the at least one memory and the computer program code configured to, with the at least one processor, cause the apparatus at least to:
determine an initial activity timing for a user device for each of a plurality of signal sources, wherein the activity timing for the user device with respect to a signal source indicates a timing of a user device activity that should be performed by the user device with respect to the signal source; and
determine an adjusted activity timing for the user device for at least one of the plurality of signal sources, such that a time order of a user device activity performed by the user device for the plurality of signal sources are arranged in time for the user device based on a length of an activity period for the plurality of signal sources, wherein the activity period for a signal source includes a time period between successive user device activities for a signal source.

2. The apparatus of claim 1 wherein the initial activity timing for a user device for each of a plurality of signal sources comprises at least one of:
an initial paging timing for a user device for each of a plurality of paging sources;
an initial timing of measurement of reference signals from each of a plurality of reference signal sources;
an initial timing of reporting of signal measurements to each of a plurality of signal sources or network nodes; or
an initial timing to receive data from each of a plurality of data sources.

3. The apparatus of claim 1, wherein the at least one processor and the computer program code configured to determine an adjusted activity timing for the user device for at least one of the plurality of signal sources comprises the at least one processor and the computer program code configured to:
send, by the user device, a request for the adjusted activity timing for at least one of the plurality of signal sources for the user device; and
receive, by the user device, a response that includes information identifying the adjusted activity timing for at least one of the plurality of signal sources for the user device.

4. The apparatus of claim 1, wherein the adjusted activity timing for the user device is determined such that a time order for the user device activity for the plurality of signal sources for the user device will be arranged in either descending order of length of activity period or ascending order of length of activity period for the plurality of signal sources.

5. The apparatus of claim 1 wherein the adjusted activity timing is determined such that user device activities, for the plurality of signal sources for the user device, having a same length of activity period, will be grouped together or adjacent to each other in time, either with or without a time gap therebetween.

6. The apparatus of claim 1:
wherein the at least one processor and the computer program code configured to determine an initial activity timing for a user device for each of a plurality of signal sources comprises the at least one processor and the computer program code configured to:
determine an initial paging timing for a user device for each of a plurality of paging sources, wherein the paging timing for the user device with respect to a paging source indicates a timing of paging monitoring instances when the user device should monitor for paging messages from the paging source; and
wherein the at least one processor and the computer program code configured to determine the means for determining an adjusted activity timing for the user device for at least one of the plurality of signal sources comprises the at least one processor and the computer program code configured to:
determine an adjusted paging timing for the user device for at least one of the plurality of paging sources, such that a time order of a paging monitoring instance for the plurality of paging sources for the user device is arranged based on a length of paging cycle for the plurality of paging sources, wherein a paging cycle for a paging source comprises a time period between successive paging monitoring instances for a paging source.

7. The apparatus of claim 6, wherein a user device identity has been assigned or reassigned to the user device for one or more of the plurality of paging sources, at least for the purposes of paging.

8. The apparatus of claim 6, wherein each of the plurality of paging sources is associated with at least one of:
a different wireless network;
a different wireless operator; or
a different radio access technology (RAT).

9. The apparatus of claim 6, wherein the at least one processor and the computer program code configured to determine an initial paging timing comprises the at least one processor and the computer program code configured to:
determine an initial paging timing for the user device for each of a plurality of paging sources based on at least one of system information associated with a respective paging source or a user device identity that has been assigned to the user device for a respective paging source.

10. The apparatus of claim 6:
wherein the adjusted paging timing is determined such that a time order of a paging monitoring instance for the plurality of paging sources for the user device will be arranged in either descending order of length of paging cycle or ascending order of length of paging cycle for the plurality of paging sources; or
wherein the adjusted paging timing is determined such that paging monitoring instances, for the plurality of paging sources for the user device, having a same length of paging cycle will be grouped together or adjacent to each other in time, either with or without a time gap therebetween.

11. The apparatus of claim 6, wherein the at least one processor and the computer program code configured to determine an adjusted paging timing for the user device for at least one of the plurality of paging sources comprises the at least one processor and the computer program code configured to:
send, by the user device to a network node, a request for an adjusted paging timing for the user device for at least one of the plurality of paging sources, such that a time order of a paging monitoring instance for the plurality of paging sources for the user device will be arranged based on a length of paging cycle for the plurality of paging sources; and
receive, by the user device from the network node in response to the request, a response including information identifying an adjusted paging timing for the user device for at least one of the paging sources.

12. The apparatus of claim 6, wherein the at least one processor and the computer program code are configured to:
perform, by the user device, reference signal measurement for reference signals received from one or more cells during a time gap between paging monitoring instances of the plurality of paging sources.

13. A method comprising:
determining an initial activity timing for a user device for each of a plurality of signal sources, wherein the activity timing for the user device with respect to a signal source indicates a timing of a user device activity that should be performed by the user device with respect to the signal source; and
determining an adjusted activity timing for the user device for at least one of the plurality of signal sources, such that a time order of a user device activity performed by the user device for the plurality of signal sources are arranged in time for the user device based on a length of an activity period for the plurality of signal sources, wherein the activity period for a signal source includes a time period between successive user device activities for a signal source.

14. A non-transitory computer-readable storage medium comprising instructions stored thereon that, when executed by at least one processor, are configured to cause a computing system to:
determine an initial activity timing for a user device for each of a plurality of signal sources, wherein the activity timing for the user device with respect to a signal source indicates a timing of a user device activity that should be performed by the user device with respect to the signal source; and
determine an adjusted activity timing for the user device for at least one of the plurality of signal sources, such that a time order of a user device activity performed by the user device for the plurality of signal sources are arranged in time for the user device based on a length of an activity period for the plurality of signal sources, wherein the activity period for a signal source includes a time period between successive user device activities for a signal source.

15. (canceled)
